(19) United States
(12) Patent Application Publication
(10) Pub. No.: US 2015/0066521 A1
(43) Pub. Date: Mar. 5, 2015

(54) EMERGENCY DEPARTMENT STATUS DISPLAY

(71) Applicant: CERNER INNOVATION, INC., Kansas City, KS (US)

(72) Inventors: AMANDA BUCKLEY, Olathe, KS (US); LESLIE LINDSEY, Kansas City, MO (US); BRADLEY SCOTT, Overland Park, KS (US); RAMKUMAR BOMMIREDDIPALLI, Overland Park, KS (US); AMBER KATHLENE MEAD, Olathe, KS (US); E. ROLLAND PHILLIPS, III, Concord, NC (US); MICHAEL RYAN KEESEE, Grain Valley, MO (US); GEOFFREY HAROLD SIMMONS, Parkville, MO (US)

(73) Assignee: CERNER INNOVATION, INC., Kansas City, KS (US)

(21) Appl. No.: 14/012,678

(22) Filed: Aug. 28, 2013

(51) Int. Cl. G06F 19/00

(52) U.S. Cl. CPC G06F 19/327
USPC 705/2

(57) ABSTRACT

Methods, computer systems, and computer-storage medium are provided for providing an emergency department centralized interactive display. A segmentable summary of patients within an ED allows a clinician to view a specific area within the ED or a summary of patients assigned to the clinician including unassigned patients sorted by acuity and length of stay. A throughput summary for a patient indicates throughput and whether actions are pending for the patient. A patient summary for the patient that includes information collected at triage, links to documentation from previous visits, care plans, a do not resuscitate order, home medications, and/or history. A provider summary provides information regarding providers for the patient and allows the clinician to designate an attending physician to the patient. In various embodiments, additional summary information is provided giving the ED clinician an efficient one-stop shop for performing ED duties.

### BACKGROUND

Clinicians in an emergency department (ED) of a healthcare facility have many responsibilities. Medications must be ordered, laboratory and electrocardiogram (EKG) results must be analyzed, images must be viewed, patient histories and care plans must be observed, and information must be documented and signed, often for many patients at a time. This requires constant searching and scrolling to identify new items (e.g., lab results or images that have not yet been analyzed or viewed) that affect efficiency and the timely discharge of patients. Exacerbating this problem further, there is no single source that allows all these responsibilities to be performed which requires additional time to find in other locations or open other applications. The result is inefficiency for the emergency department clinician, as well as increased length of stays for the affected patients.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-storage media for providing an emergency department centralized interactive display. A segmentable summary of patients within an ED allows a clinician to view a specific area within the ED or a summary of patients assigned to the clinician including unassigned patients sorted by acuity and length of stay. A throughput summary for a patient indicates throughput and whether actions are pending for the patient. The throughput may indicate whether the patient is pending arrival, waiting for a clinician, an exam has been completed, orders are pending, orders are completed, the patient is ready for discharge, and/or the patient is pending admission. A patient summary for the patient that includes information collected at triage, links to documentation from previous visits, care plans, a do not resuscitate order, home medications, and/or history. A provider summary provides information regarding providers for the patient and allows the clinician to designate an attending physician to the patient. In various embodiments, a consult summary, an order summary, a vitals summary, a length of stay summary, an acuity summary, and/or a documentation summary are provided giving the ED clinician an efficient one-stop shop for performing ED duties.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary system for providing an emergency department centralized interactive display suitable to implement embodiments of the present invention;

FIGS. 3-30 depict illustrative screen displays, in accordance with exemplary embodiments of the present invention; and

FIG. 31 is a flow diagram of an exemplary method providing an emergency department centralized interactive display, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-storage media for providing an emergency department centralized interactive display. The emergency department centralized interactive display provides the ED clinician an efficient one-stop shop for performing ED duties.

Accordingly, one embodiment of the present invention is directed to one or more computer hardware storage media storing computer-useable instructions that, when used by one or more computing devices, cause the one or more computing devices to perform a method of providing an emergency department centralized interactive display. The method includes providing a segmentable summary of patients within an emergency department (ED). The segmentable summary allowing a clinician to view a specific area within the ED or a summary of patients assigned to the clinician including unassigned patients sorted by acuity and length of stay. A throughput summary for a patient is provided that indicates throughput and whether actions are pending for the patient. The throughput indicates whether the patient is pending arrival, waiting for a clinician, an exam has been completed, orders are pending, orders are completed, the patient is ready for discharge, and/or the patient is pending admission. A patient summary for the patient is provided that includes information collected at triage, links to documentation from previous visits, care plans, a do not resuscitate order, home medications, and/or history. A provider summary is provided that provides information regarding providers for the patient and allows the clinician to designate an attending physician to the patient.

Another embodiment of the present invention includes a system for providing an emergency department centralized interactive display. The system includes one or more processors coupled to a computer storage medium, the computer storage medium having stored thereon a plurality of computer software components executable by the processor. The computer software components include a patient summary component that provides a patient summary for a patient. The patient summary includes information collected at triage, links to documentation from previous visits, care plans, a do not resuscitate order, home medications, and/or history. A provider summary component provides a provider summary. The provider summary provides information regarding providers for the patient and allows the clinician to designate an attending physician to the patient. A vitals summary component provides a vitals summary that indicates the most recent vitals measurements and further indicates if any vital readings are stale, critical and/or have not been reviewed, or if no vital readings are available. A medications summary component provides a medications summary that indicates medications that have been ordered or administered to the patient and allows the clinician to place new orders directly from an orders hover window associated with the medications summary and without having to go into a chart associated with the patient. A laboratory summary component provides a medications summary that indicates medications that have been ordered for or administered to the patient. The medication summary further allows the clinician to place new orders directly from an orders hover window associated with the medications summary and without having to go into a chart associated with the patient. An electrocardiogram (EKG) summary component provides an electrocardiogram (EKG) summary that provides details of EKG orders, a status of the EKG, and/or a link to the EKG results. An images summary component provides an images summary that provides a status of an order for an image, order details, a link to the image, a status of documentation for the image, and/or a link to provide documentation after the image is read. A length of stay summary component provides a length of stay summary that indicates a status associated with a length of stay and includes a timer to alert the clinician if a threshold has been exceeded for the patient. A documentation summary component provides a documentation summary that indicates a status associated with documentation for the patient and enables the clinician to update the documentation. An acuity summary component provides an acuity summary for the patient that indicates an acuity for the patient.

Yet another embodiment of the present invention is directed to computer storage media having computer-executable instructions embodied thereon that, when executed by one or more computing devices, cause the one or more computing devices to produce a graphical user interface (GUI) for providing an emergency department centralized interactive display. The GUI includes a segment display area that displays a view of a specific area within the ED or a summary of patients assigned to the clinician including unassigned patients sorted by acuity and length of stay. An acuity display area displays an acuity for the patient. The acuity may be color coded based on severity. A throughput display area displays throughput for a patient and indicates whether actions are pending for the patient. The throughput may indicate whether the patient is waiting for a clinician, an exam has been completed, orders are pending, orders are completed, the patient has been discharged, and/or the patient is pending admission. A patient display area displays information collected at triage, links to documentation from previous visits, care plans, a do not resuscitate order, home medications, and/or history. A provider display area displays information regarding providers for the patient and allows the clinician to designate an attending physician to the patient. The provider display area may include placeholders for specific clinician positions to maintain uniformity for the provider display area for each patient. A consult display area displays whether a consult has been requested and allows the clinician to initiate the consult. An orders/vitals display area displays an order summary that indicates a status associated with orders for the patient and a vitals summary that indicates the most recent vitals measurements, displays alerts to the clinician if any vital readings are stale, displays alerts to the clinician if any vital readings are critical and have not been reviewed, or displays alerts to the clinician if no vital readings are available.

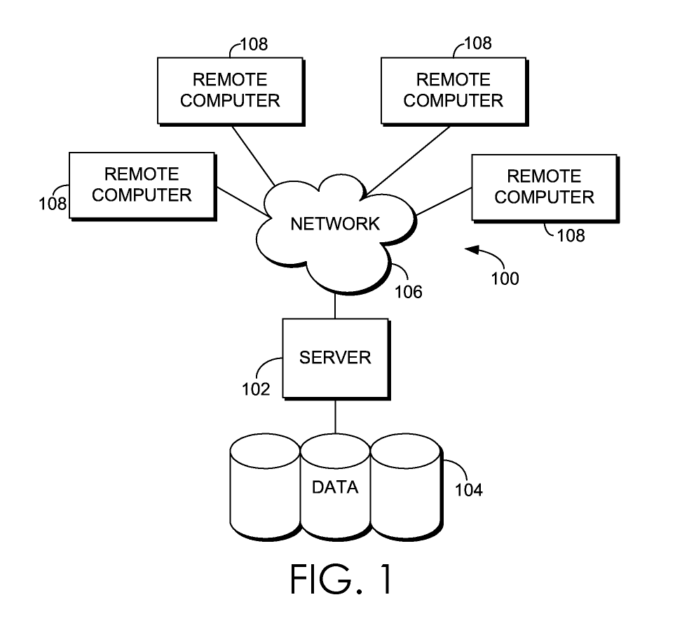

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

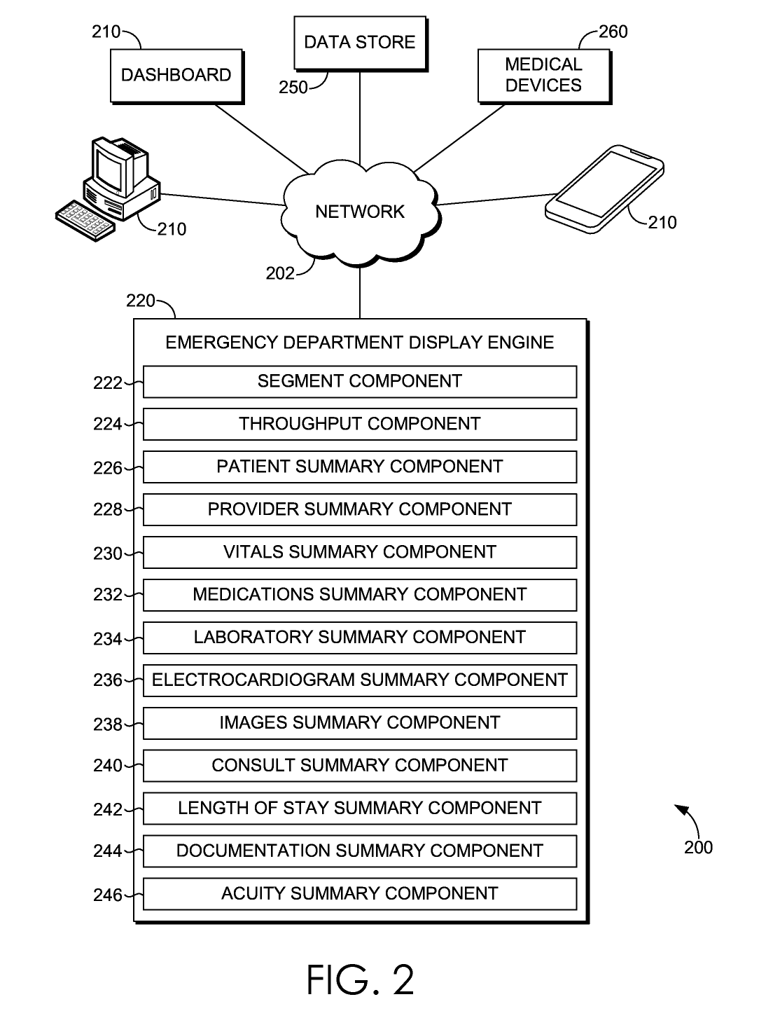

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a display device 210 (e.g., dashboard, computer, mobile device, and the like), emergency department display engine 220, data store 250, and medical devices 260 all in communication with one another via a network 202. The network 202 may include, without limitation, one or more secure local area networks (LANs) or wide area networks (WANs). The network 202 may be a secure network associated with a facility such as a healthcare facility. The secure network 202 may require that a user log in and be authenticated in order to send and/or receive information over the network 202.

In some embodiments, one or more of the illustrated components/modules may be implemented as stand-alone applications. In other embodiments, one or more of the illustrated components/modules may be distributed across multiple emergency department display engines 220. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the emergency department display engines 220 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 250 is configured to store information for use by, for example, the emergency department display engine 220. The information stored in association with the data store 250 is configured to be searchable for one or more items of information stored in association therewith. The information stored in association with the data store 250 may comprise information used by various components of the emergency department display engine 220.

The data store 250 may store electronic medical records (EMRs) of patients associated with one or more healthcare facilities. EMRs may comprise electronic clinical documents such as images, clinical notes, orders, summaries, reports, analyses, information received from medical devices 260, or other types of electronic medical documentation relevant to a particular patient's condition and/or treatment. Electronic clinical documents contain various types of information relevant to the condition and/or treatment of a particular patient and can include information relating to, for example, patient identification information, images, alert history, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, clinician assignments, and a host of other relevant clinical information.

The content and volume of such information in the data store 260 are not intended to limit the scope of embodiments of the present invention in any way. Further, though illustrated as a single, independent component, the data store 260 may, in fact, be a plurality of storage devices, for instance, a database cluster.

The display devices 210 may be any type of display device capable of communicating on the network 202 with the emergency department display engine 220, the data store 250, or the medical devices 260. Such devices may include any type of mobile and portable devices including cellular telephones, personal digital assistants, tablet PCs, smart phones, and the like.

The display of the display device 210 is configured to display information to the user of the display device 210. The information may include communications initiated by and/or received by the emergency department display engine 220. Embodiments are not intended to be limited to visual display but rather may also include audio presentation, combined audio/visual presentation, and the like.

Components of the emergency department display engine 220 may include a processing unit, internal system memory, and a suitable system bus for coupling various system components, including one or more data stores for storing information (e.g., files and metadata associated therewith). The emergency department display engine 220 typically includes, or has access to, a variety of computer-readable media.

The computing system environment 200 is merely exemplary. While the emergency department display engine 220 is illustrated as a single unit, it will be appreciated that the emergency department display engine 220 is scalable. For example, the emergency department display engine 220 may in actuality include a plurality of computing devices in communication with one another. The single unit depictions are meant for clarity, not to limit the scope of embodiments in any form.

As shown in FIG. 2, the emergency department display engine 220 comprises, in various embodiments a segment component 222, a throughput component 224, a patient summary component 226, a provider summary component 228, a vitals summary component 230, a medications summary component 232, a laboratory summary component 234, an electrocardiogram summary component 236, an images summary component 238, a consult summary component 240, a length of stay summary component 242, a documentation summary component 244, and an acuity summary component 246. In some embodiments, one or more of the components may be implemented as stand-alone applications. It will be understood that the components illustrated in FIG. 2 are exemplary in nature and in number and should not be construed as limiting. Any number of components may be employed to achieve the desired functionality within the scope of embodiments hereof.

In one embodiment, segment component 222 provides a segmentable summary of patients within an emergency department (ED). The segmentable summary may allow a clinician to view a specific area within the ED. The segmentable summary may allow a clinician to view a summary of patients assigned to the clinician. The summary may include unassigned patients sorted by acuity and length of stay.

In one embodiment, throughput component 224 provides a throughput summary for a patient that indicates throughput and whether actions are pending for the patient. The throughput may indicate whether the patient is pending arrival. The throughput may indicate whether the patient is waiting for a clinician. The throughput may indicate whether an exam has been completed. The throughput may indicate whether orders are pending or completed. The throughput may indicate whether the patient is ready for discharge. The throughput may indicate whether the patient is pending admission.

Patient summary component 226 provides a patient summary for a patient. The patient summary includes information collected at triage, links to documentation from previous visits, care plans, a do not resuscitate order, home medications, and/or history. The patient summary component 226 may further provide a chief complaint provided by the patient, as well as any accompanying notes or comments.

Provider summary component 228 provides a provider summary. The provider summary provides information regarding providers for the patient. The provider summary further allows the clinician to designate an attending physician to the patient. To maintain uniformity for the provider summary, provider summary component 228 provides placeholders for specific clinician positions.

Vitals summary component 230 provides a vitals summary that indicates the most recent vitals measurements. The vitals summary further indicates if any vital readings are stale, critical and/or have not been reviewed, or if no vital readings are available. The vitals summary component 230 further allows the clinician to place new orders directly from an orders hover window associated with the vitals summary without having to go into a chart associated with the patient.

Medications summary component 232 provides a medications summary. The medications summary indicates medications that have been ordered or administered to the patient. The medications summary further allows the clinician to place new orders directly from an orders hover window associated with the medications summary without having to go into a chart associated with the patient.

Laboratory summary component 234 provides a laboratory summary. The laboratory summary indicates whether results are completed, whether the results are overdue, whether the results have been reviewed, and allows the clinician to review the results directly from a results hover window associated with the laboratory summary and without having to go into the chart associated with the patient.

Electrocardiogram (EKG) summary component 236 provides an electrocardiogram (EKG) summary. The EKG summary provides details of EKG orders, a status of the EKG, and/or a link to the EKG results. Images summary component 238 provides an images summary that provides a status of an order for an image, order details, a link to the image, a status of documentation for the image, and/or a link to provide documentation after the image is read.

In one embodiment, consult summary component 240 provides a consult summary that indicates whether a consult has been requested and allows the clinician to perform the consult.

Length of stay summary component 242 provides a length of stay summary that indicates a status associated with a length of stay and includes a timer to alert the clinician if a threshold has been exceeded for the patient. The status may be the status provided by the throughput component 224. The timer may count upwards or downwards to help the facility track the time required at each status for the patient.

Documentation summary component 244 provides a documentation summary that indicates a status associated with documentation for the patient and enables the clinician to update the documentation. For example, the document summary component 244 may indicate that documentation has not been started (e.g., blank), documentation is in progress (e.g., filled), documentation is complete (e.g., filled with check), a multi-contributor document is complete (e.g., filled with green “chat” icon), or a multi-contributor document is not complete (e.g., filled with red “chat” icon). The document summary component 244 may further allow a clinician to provide additional documentation, such as by selecting a button or otherwise interacting with the display. This allows the clinician to provide documentation without opening another application or an EMR associated with the patient.

Acuity summary component 246 provides an acuity summary for the patient that indicates an acuity for the patient. The acuity summary may be color coded based on severity. The acuity summary may further have a numerical indicator providing the clinician additional information regarding the severity. The color coding and the numerical identifier serve as a visual triage indicator allowing the clinician to quickly identify the patient in the most urgent need of attention. For example, the color may be a lighter shade for a severity of five, indicating to the clinician that the acuity is not currently severe. A darker color such as a bright red may be utilized for a severity of one, indicating to the clinician that the acuity is very severe.

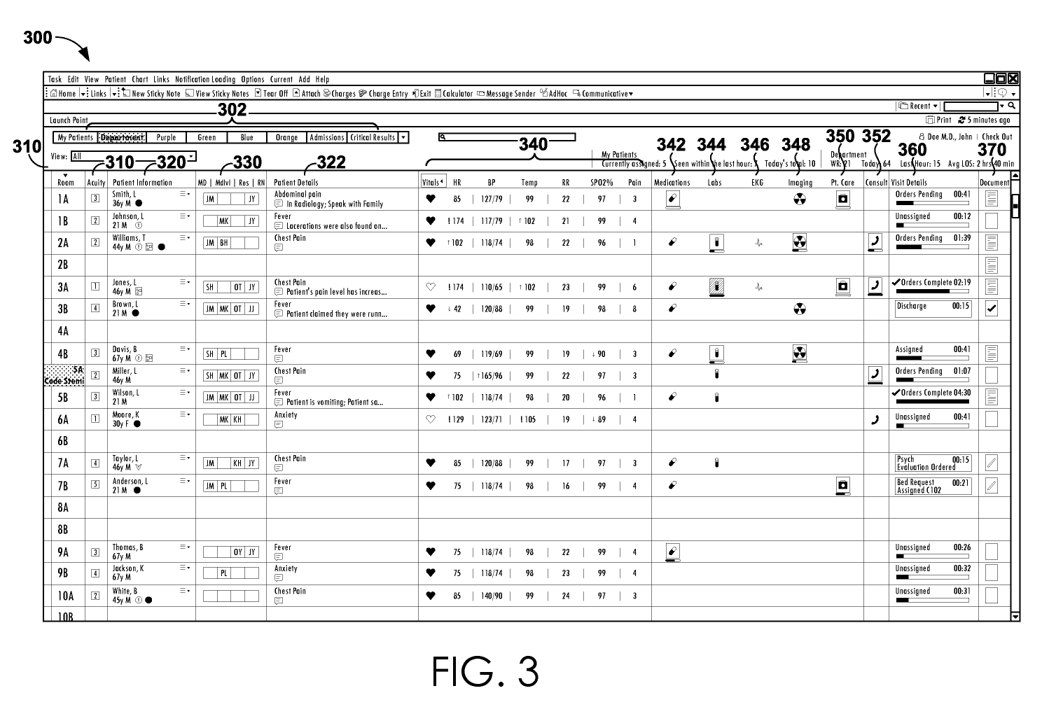

With reference to FIGS. 3-27, illustrative screen displays for providing an emergency department centralized interactive display are provided. It is understood that each of the illustrative screen displays are connected logically, such that they comprise a user interface designed for providing an emergency department centralized interactive display. The screen displays may appear in any order and with any number of screen displays, without regard to whether the screen display is described or depicted herein. The screen displays provide a streamlined view of a patient and a status of the patient within the emergency department. In one embodiment, a first portion of screen displays provides information about the patient and why the patient is in the emergency department. In one embodiment, a second portion of screen displays provides information on physician interventions and a progress associated with the physician interventions. In one embodiment, a third portion of screen displays provides a throughput indicating the position or status of the emergency department visit and the items that need to be completed for the patient to be discharged or admitted.

Referring now to FIG. 3, an illustrative screen display 300 of an embodiment of the present invention is shown. A segment display area 302 displays a view of a specific area within the ED or a summary of patients assigned to the clinician including unassigned patients sorted by acuity and length of stay. The segment display area 302 may allow the clinician to control the desired view, such as by selecting the desired area or summary.

A throughput display area 310 displays through for a patient and indicates whether actions are pending for the patient. In one embodiment, the throughput indicates whether the patient is pending arrival. In one embodiment, the throughput indicates whether the patient is waiting for a clinician. In another embodiment, the throughput indicates an exam has been completed. In another embodiment, the throughput indicates orders are pending. In another embodiment, the throughput indicates orders are completed. In another embodiment, the throughput indicates the patient is ready for discharge. In another embodiment, the throughput indicates the patient is pending admission. In one embodiment, a light presented within the throughput display area 310 indicates actions are pending for the patient.

An acuity display area 312 displays an acuity for the patient. The acuity may be color coded based on severity. The acuity may further have a numerical indicator providing the clinician additional information regarding the severity. The color coding and the numerical identifier serve as a visual triage indicator allowing the clinician to quickly identify the patient in the most urgent need of attention. For example, the color may be a lighter shade for a severity of five, indicating to the clinician that the acuity is not currently severe. A darker color such as a bright red may be utilized for a severity of one, indicating to the clinician that the acuity is very severe.

Provider display area 320 displays information regarding providers for the patient. Provider display area 320 further allows a clinician to designate an attending physician to the patient. To maintain uniformity for the provider display area 320, provider display area 320 includes placeholders for specific clinician positions.

Patient display area 330 displays information associated with the patient. The information may include information collected at triage. The information may further include links to documentation from previous visits. The information may further include care plans, a do not resuscitate order, home medications, and/or history. The information and the links allow a clinician to review pertinent information regarding the patient from the emergency department centralized interactive display without needing to open another application or open the patient's EMR. The information may further include a chief complaint provided by the patient, as well as any accompanying comments or notes.

An orders/vitals display area 340, 342, 344, 346, 348, 350, 352 displays an order summary and a vitals summary. If a column in the orders/vitals display area 340, 342, 344, 346, 348, 350, 352 is blank, nothing has taken place for that particular order type. If an icon appears, in one embodiment, but with no color coding, an order has taken place for that particular order type, and it is not yet overdue. If an icon appears, in one embodiment, with a glowing box, the order for that particular type is overdue. If an icon appears, in one embodiment, with a grey color coding, the order for that particular order type is completed with normal results that have not yet been reviewed. If an icon appears, in one embodiment, with a red color coding, the order for that particular order type is completed with critical results that have not yet been reviewed. If an icon appears, in one embodiment, in the vitals column with a grey heart, the patient has normal vital signs. If an icon appears, in one embodiment, in the vitals column with a red heart, the patient has critical vital signs. As can be appreciated, any color coding or indication can be utilized to alert a clinician to any condition or status for any of the vitals or orders described herein. Status bars may further visually indicate a progress for all pending orders (i.e., number of items completed against the entire order for each order category) so the clinician can easily identify a percentage of items completed. The status bar may further utilize color coding or shading to indicate if new items that are critical or new items that have been completed and have not yet been reviewed or if a configurable threshold has passed since the order was placed indicating the order is taking too long to process or administer.

The vitals summary 340 indicates the most recent vitals measurements, displays alerts to the clinician if any vital readings are stale, displays alerts to the clinician if any vital readings are critical and have not been reviewed, or displays alerts to the clinician if no vital readings are available. The order summary indicates a status associated with orders for the patient.

In one embodiment, the order summary includes a medications summary 342. The medications summary 342 indicates medications that have been ordered or administered to the patient and allows the clinician to place new orders directly from an orders hover window associated with the medications summary and without having to go into a chart associated with the patient.

In one embodiment, the order summary includes a laboratory summary 344. The laboratory summary 344 indicates whether results are completed, whether the results are overdue, whether the results have been reviewed, and allows the clinician to review the results directly from a results hover window associated with the laboratory summary and without having to go into the chart associated with the patient.

In one embodiment, the order summary includes an electrocardiogram (EKG) summary 346. The EKG summary 346 provides details of EKG orders, a status of the EKG, and/or a link to the EKG results; and an images summary that provides a status of an order for an image, order details, a link to the image, a status of documentation for the image, and/or a link to provide documentation after the image is read.

In one embodiment, the order summary includes an images summary 348 that indicates a status of an order for an image. The images summary may further provide order details. A link to the image may be provided by the images summary that allows the clinician to open the image from the emergency department centralized interactive display without having to open another application. The images summary may further indicate a status of documentation for the image. The status may alert the clinician that documentation has been provided or that documentation is still needed. A link to provide documentation after the image is read may also be provided allowing the clinician to open a documentation window and provide documentation from the emergency department centralized interactive display without having to open another application.

In one embodiment, the order summary includes a patient care summary 350 that indicates a status of various tasks that have been ordered to care for the patient. These tasks may include tasks provided by any clinician assigned to the patient.

In one embodiment, the order summary includes a consult summary 352 that indicates a consult has been requested. The indication allows the clinician to recognize when a patient has requested a consult. Further, the consult summary 352 may allow the clinician to initiate the consult, such as by clicking a button or otherwise interacting with the display.

In one embodiment, a length of stay display area 360 displays a status associated with a length of stay. The length of stay display area 360 may include a timer to alert the clinician if a threshold has been exceeded for the patient. The length of stay display area 360 may further be color coded as described herein with respect to other features and display areas of the emergency department centralized interactive display.

In one embodiment, a documentation display area 370 indicates a status associated with documentation for the patient. For example, the documentation display area 370 may indicate that documentation has not been started (e.g., blank), documentation is in progress (e.g., filled), documentation is complete (e.g., filled with check), a multi-contributor document is complete (e.g., filled with green “chat” icon), or a multi-contributor document is not complete (e.g., filled with red “chat” icon). The documentation display area 370 may further allow a clinician to provide additional documentation, such as by selecting a button or otherwise interacting with the display. This allows the clinician to provide documentation without opening another application or an EMR associated with the patient.

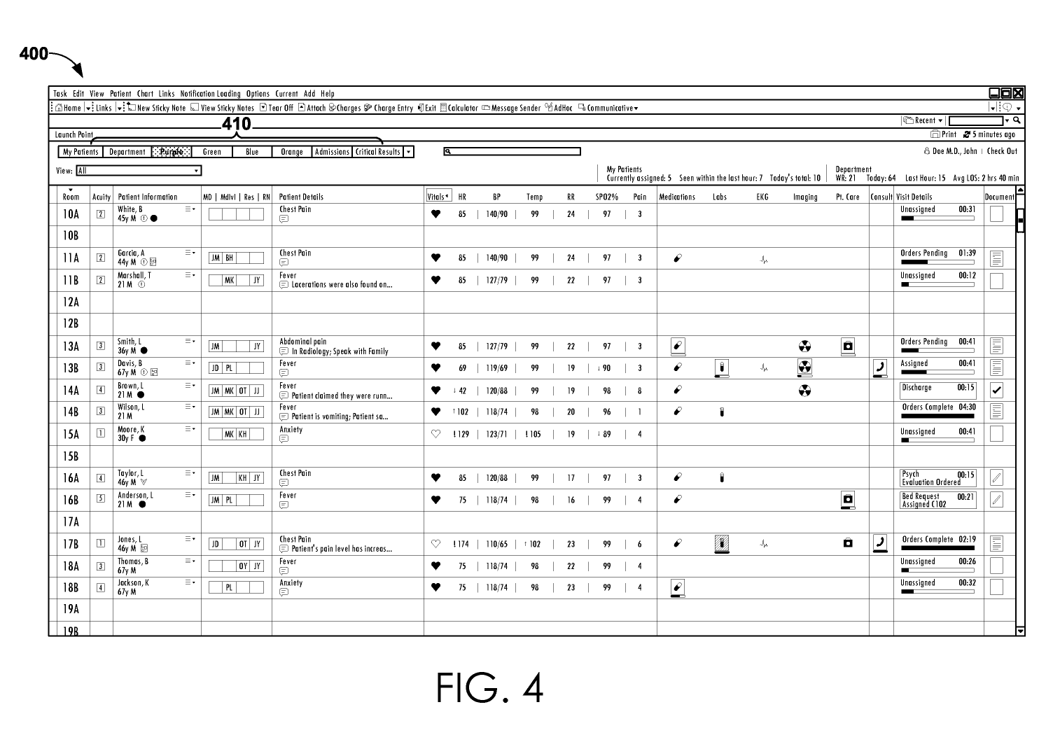

In FIG. 4, an illustrative screen display 400 of an embodiment of the present invention is shown. The segment display area 410 allows the clinician to control the desired view, such as by selecting the desired area or summary. In this example, the clinician can select between “My Patients”, “Department”, “Purple”, “Green”, “Blue”, “Orange”, “Admission”, or “Critical Results”. Upon selection, the desired view is displayed. As can be appreciated, the views can be configured or customized by each facility or clinician as desired.

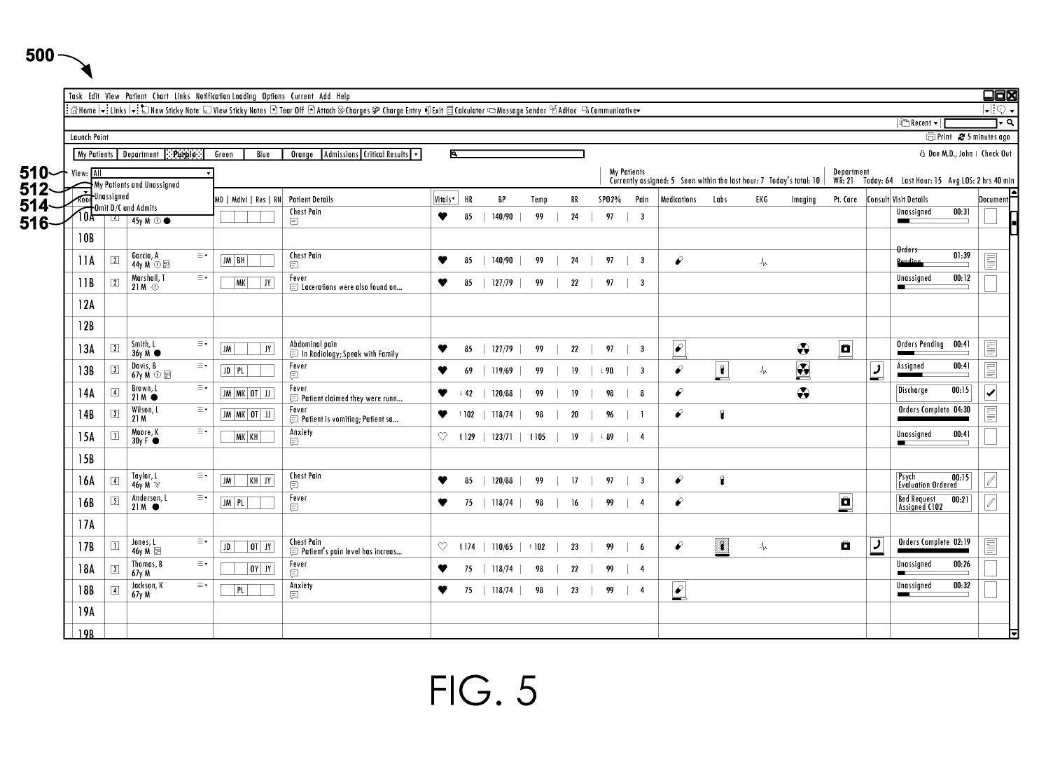

Turning now to FIG. 5, an illustrative screen display 500 of an embodiment of the present invention is shown. As illustrated, the desired view may further be selected by a dropdown menu 510. The dropdown menu 510 may contain more or additional views not available in the segment display area, such as customized views. In this example, the clinician can select “My Patients and Unassigned” 512, “Unassigned” 514, or “Omit D/C and Admits” 516.

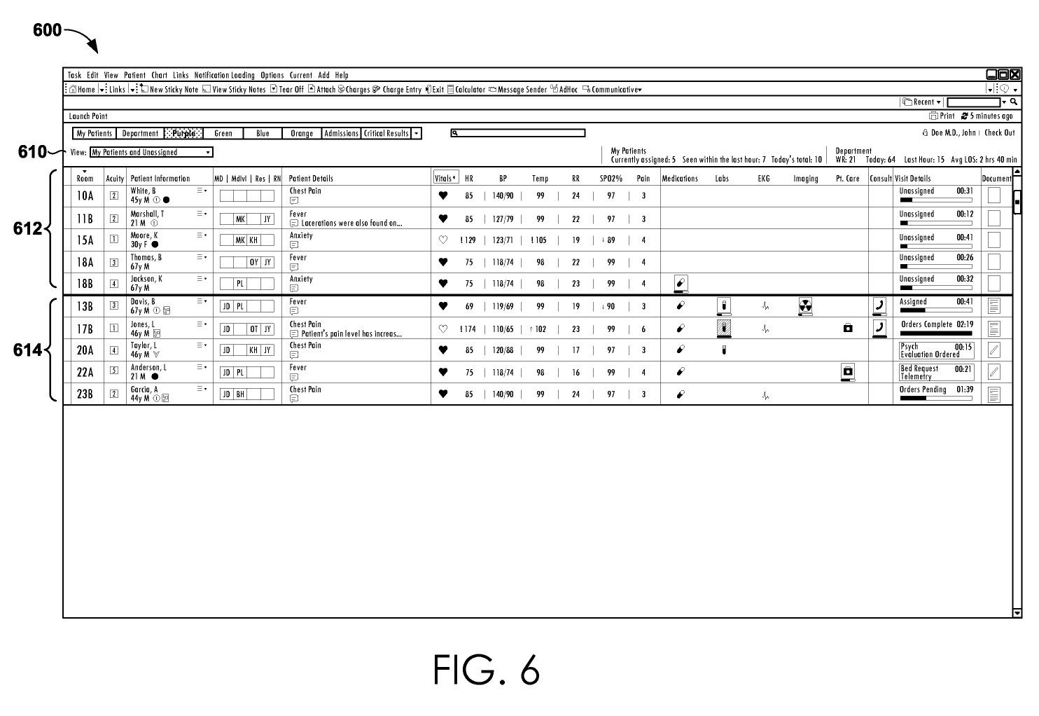

Referring now to FIG. 6, an illustrative screen display 600 of an embodiment of the present invention is shown. Continuing the example illustrated in FIG. 5, when the clinician selects “My Patients and Unassigned” 610, the unassigned patients 612 may be displayed and sorted by acuity and length of stay, so the most acute patient waiting for the longest time appears most prominently (e.g., at the top of the list). The patients 614 already assigned to the clinician are also displayed.

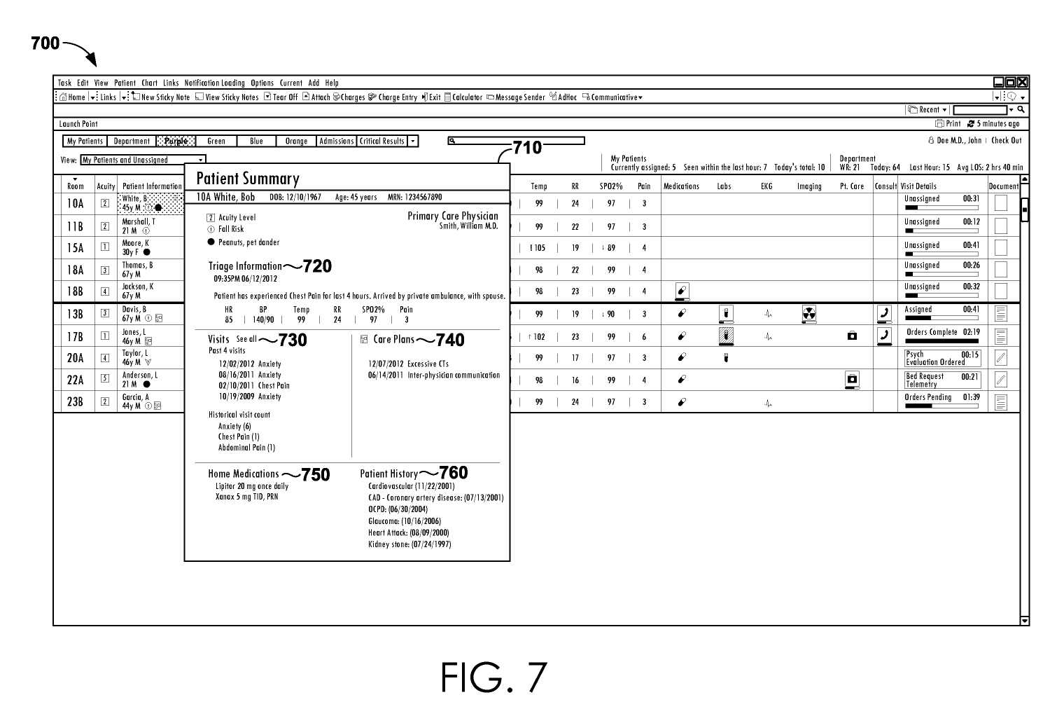

In FIG. 7, an illustrative screen display 700 of an embodiment of the present invention is shown. By interacting with a particular patient's name, the patient display area 710 is provided. The patient display area 710 displays information associated with the patient. The information may include information collected at triage 720. The information may further include links to documentation from previous visits 730. The information may further include care plans 740, a do not resuscitate order (not shown in FIG. 7), home medications 750, and/or history 760. The patient display area 710 may further provide links to documentation from current and past encounters (e.g., care plans/critical notes, physician notes, discharge summaries, etc.). The patient display area 710 is configurable so the desired links are displayed. The information and the links allow a clinician to review pertinent information regarding the patient from the emergency department centralized interactive display without needing to open another application or open the patient's EMR.

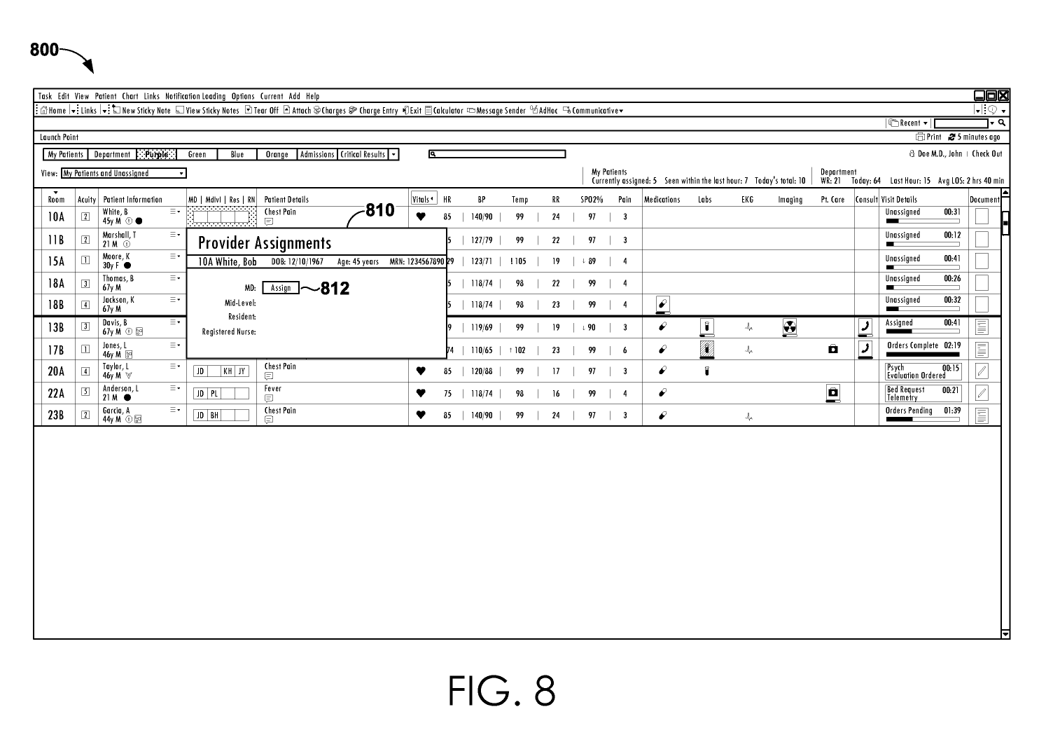

Turning now to FIG. 8, an illustrative screen display 800 of an embodiment of the present invention is shown. By hovering over or interacting with the provider display area for a particular patient, a provider assignment window 810 is provided allowing the clinician to designate (e.g., an assign button 812) an attending physician for the patient.

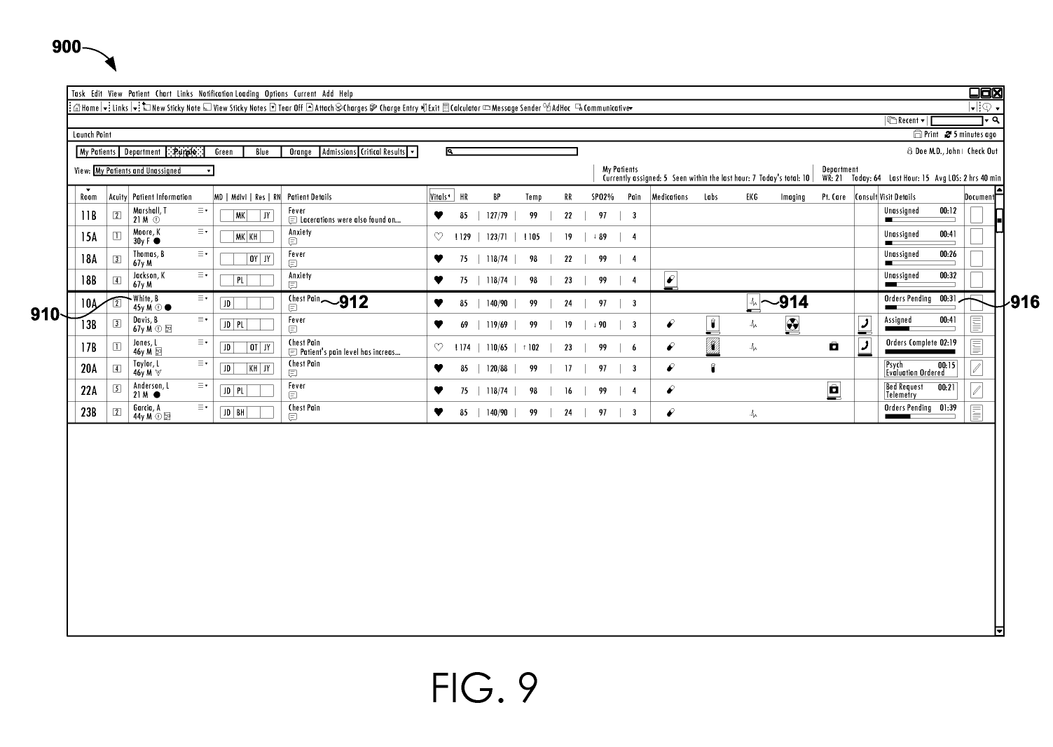

Referring now to FIG. 9, an illustrative screen display 900 of an embodiment of the present invention is shown. Continuing the example from FIG. 8, after the clinician selects to designate herself as the attending physician, the patient, “White, B.” 910, is moved to the clinician's “My Patients” area. The clinician's initials “JD” now appear in the MD column 922 of the provider display area 920. Because the patient came in with chest pain, as illustrated in by the chief complaint 912, an EKG order is automatically placed resulting in an EKG icon 914. The length of stay display area 916 shows that orders are pending, the progress of the orders, and the current time lapsed.

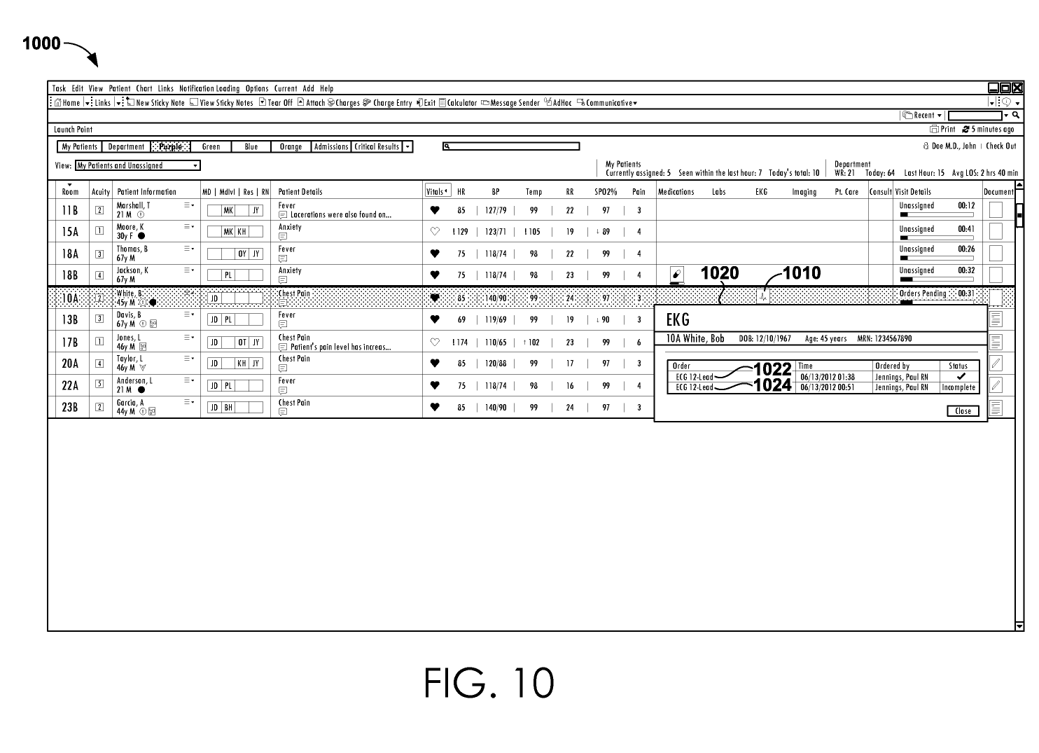

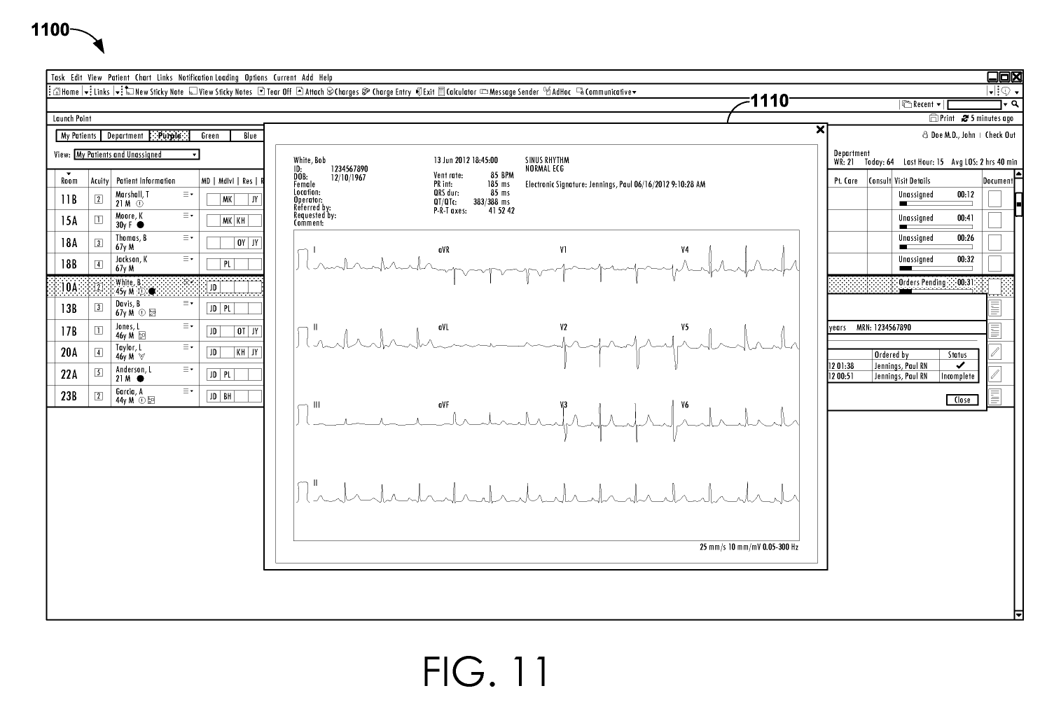

In FIG. 10, an illustrative screen display 1000 of an embodiment of the present invention is shown. By hovering or interacting with the EKG icon 1010, the EKG summary 1020 appears. The EKG summary displays each EKG order. As illustrated in the status column, the first EKG order 1022 is complete and the second EKG order 1024 is incomplete or pending. Turning now to FIG. 11, an illustrative screen display 1100 of an embodiment of the present invention is shown. By selecting a link to the completed EKG order, the EKG results 1110 are provided.

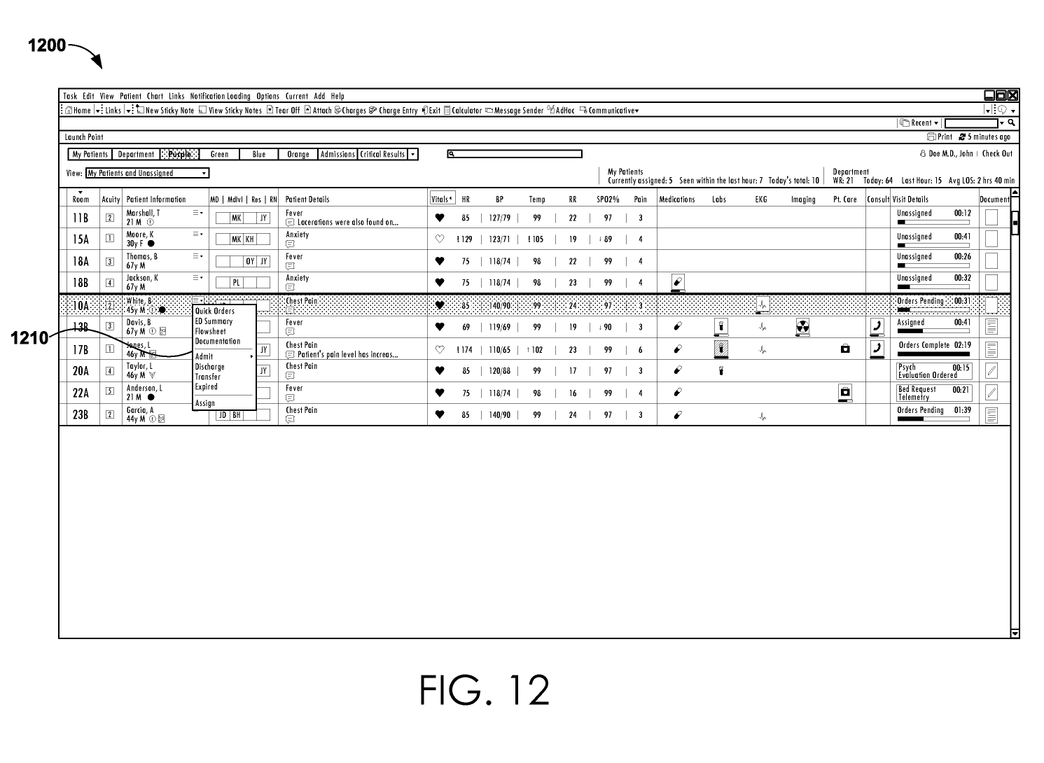

Referring now to FIG. 12, an illustrative screen display 1200 of an embodiment of the present invention is shown. By hovering over or interacting with the patient's name, such as by clicking on a dropdown menu 1210, options are presented to the clinician. The options may include “Quick Orders”, “ED Summary”, “Flowsheet”, “Documentation”, “Admit”, “Discharge”, “Transfer”, “Expired”, or “Assign”. Other options not shown in FIG. 12 may include prearrival and discharge process. Each of these options may be selected without opening another application.

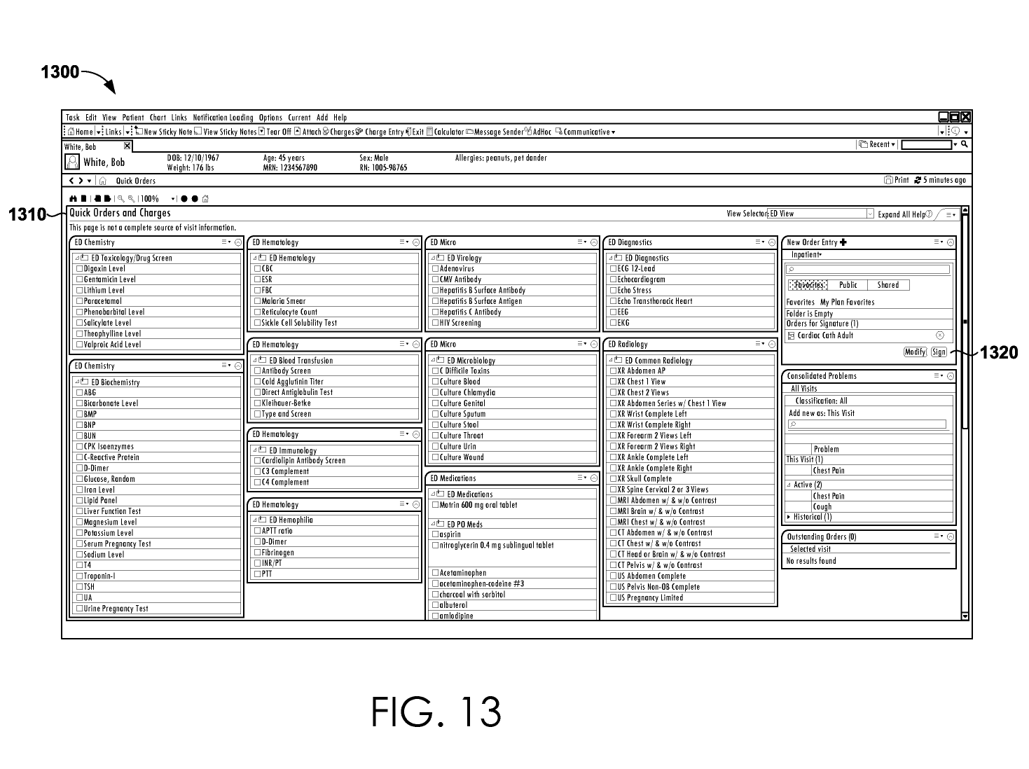

In FIG. 13, an illustrative screen display 1300 of an embodiment of the present invention is shown. By selecting or interacting with the “Quick Orders” option in FIG. 12, a quick orders display area 1310 is provided. The quick orders display area 1310 allows the clinician to place single orders or ordersets. After selecting all desired orders, the clinician can sign the orders directly in the quick orders display area 1310, without opening another application or the patient's EMR, such as by selecting or interacting with a sign button 1320.

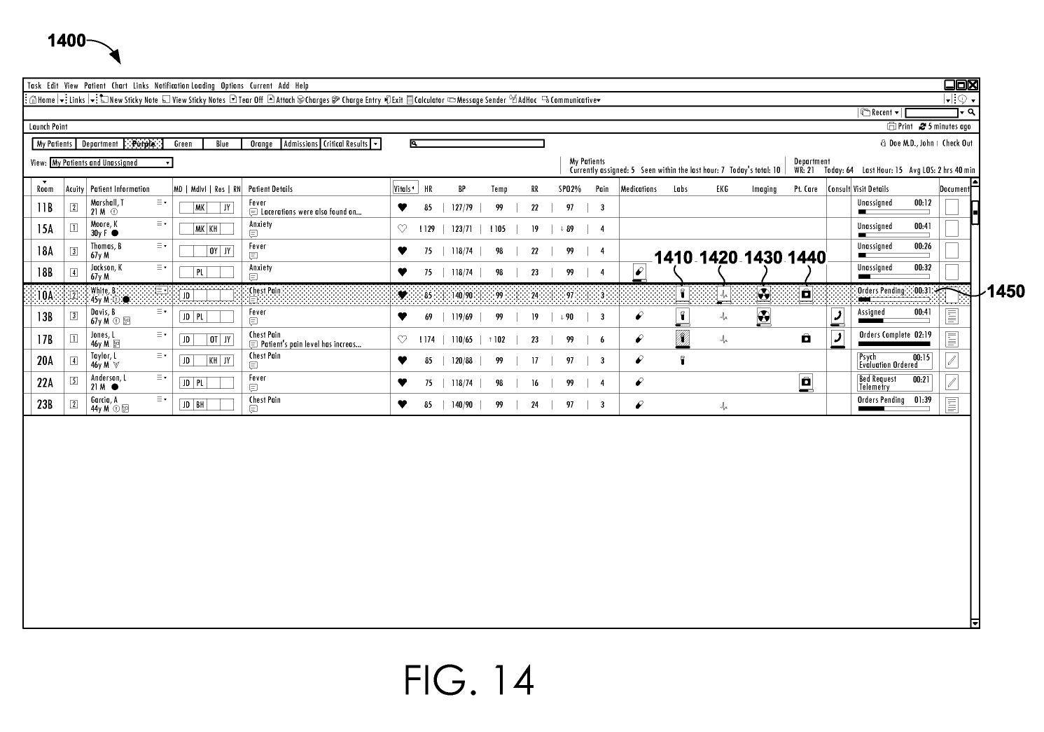

Turning now to FIG. 14, an illustrative screen display 1400 of an embodiment of the present invention is shown. After the desired orders are signed and processed, the emergency department centralized interactive display is updated with the appropriate icons. For example, for patient “White, B.”, orders have been placed for labs 1410, EKG 1420, imaging 1430, and patient care 1440. The length of stay area 1450 is also updated with the status “Orders Pending”. As already discussed, the length of stay area 1450 also includes a status bar that indicates the progress of a particular status for each patient (i.e., in this case, the progress of the pending orders).

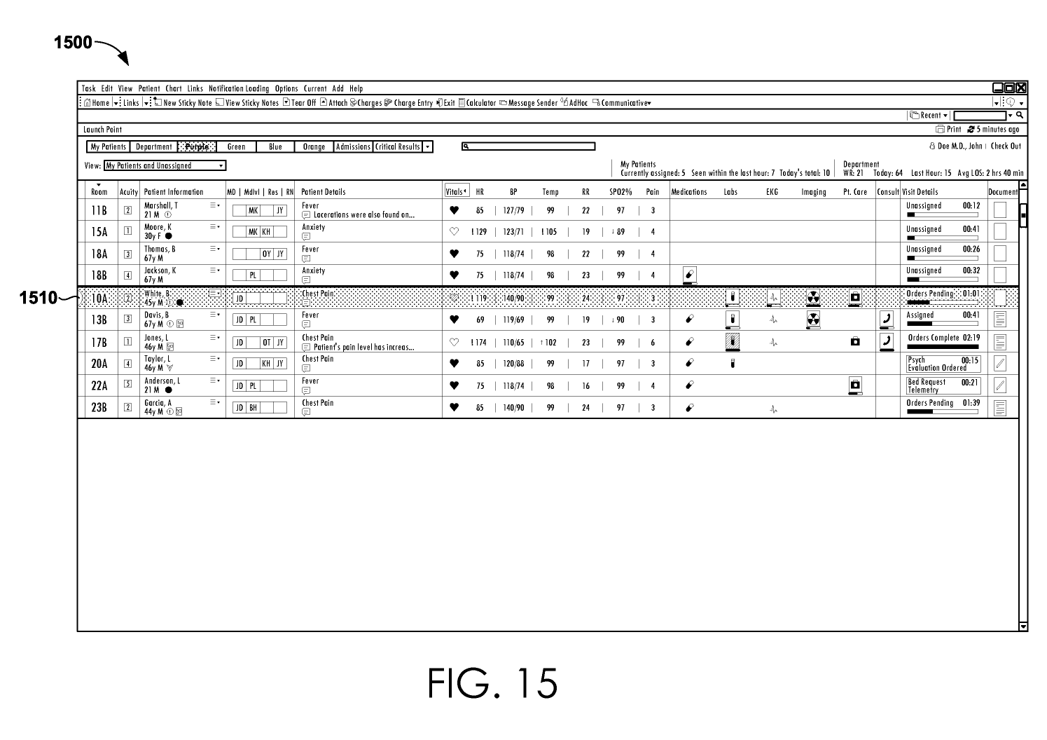

Referring now to FIG. 15, an illustrative screen display 1500 of an embodiment of the present invention is shown. As illustrated, in the throughput display area, a glow or light bulb 1510 indicates that some type of action is needed by the clinician. The actions can be information that another clinician has flagged within documentation for the clinician's attention, or may be orders that need to be co-signed. By hovering over or clicking on the glow 1510, the clinician is provided with details associated with the action. The clinician may also take appropriate action from within the same window that provides the details.

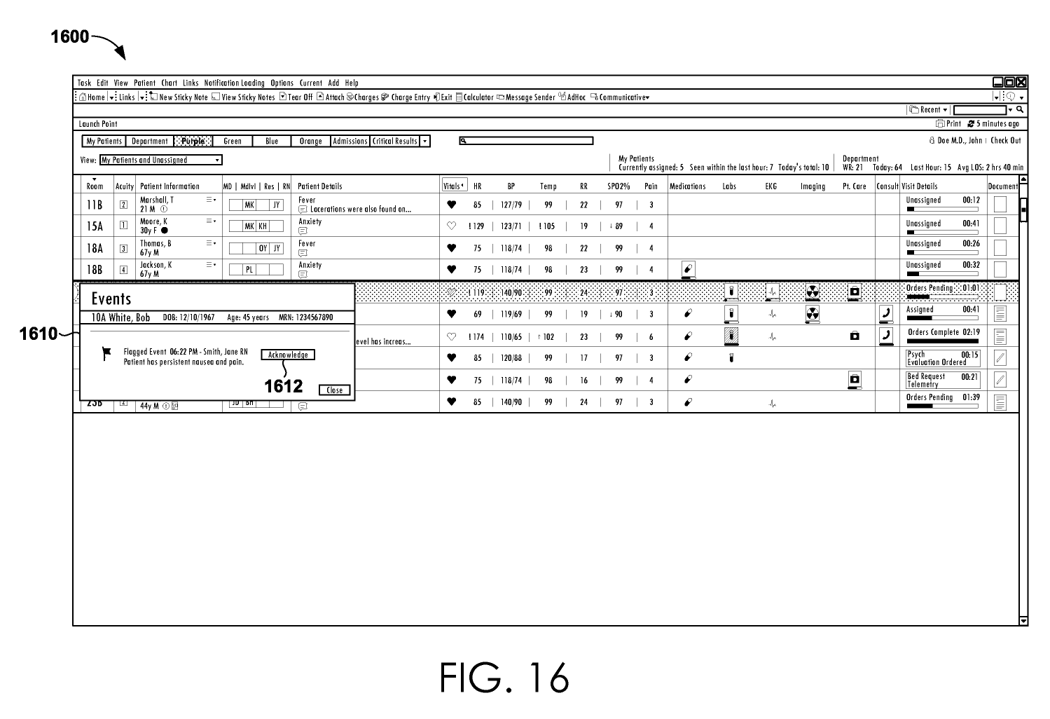

In FIG. 16, an illustrative screen display 1600 of an embodiment of the present invention is shown. After hovering over or interacting with the glow, details 1610 are provided to the clinician. In this example, a nurse has documented that the patient is experiencing persistent nausea and pain and has flagged this for review by the clinician. Once the clinician has reviewed, the clinician can acknowledge this documentation by, for example, selecting an acknowledge button 1612 from within the same window and without opening another application or the patient's EMR. The details provided may also indicate information associated with the status of the patient as also provided by length of stay display area.

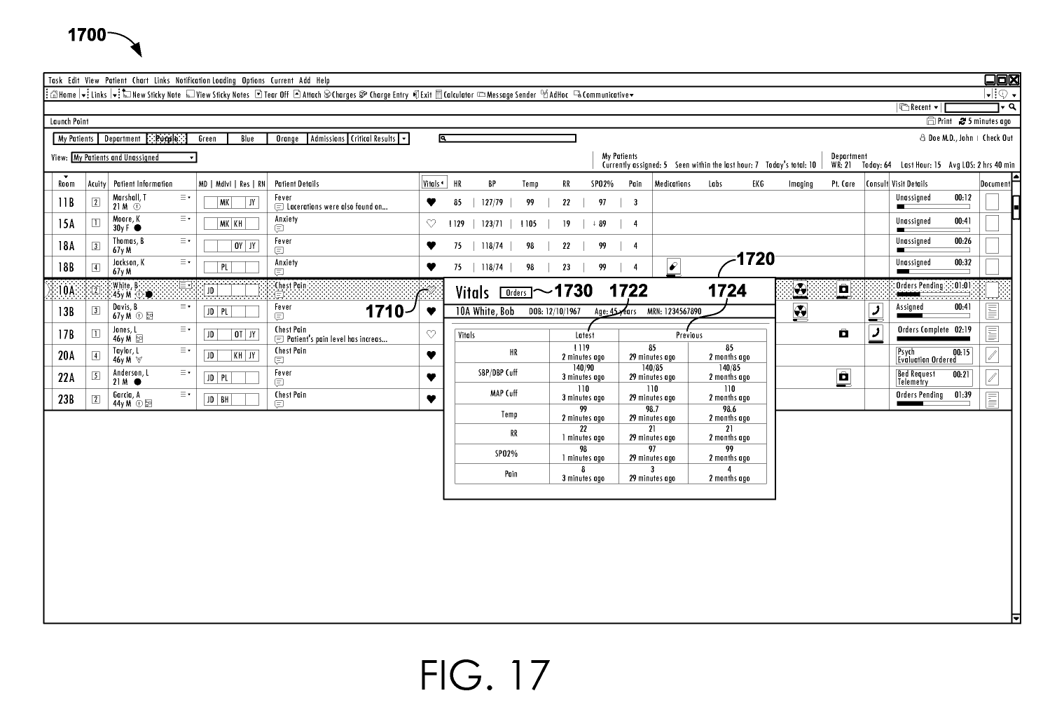

Turning now to FIG. 17, an illustrative screen display 1700 of an embodiment of the present invention is shown. By hovering over or interacting with the vital signs icon 1710, the vital signs summary 1720 is provided. The vitals summary provides the latest vital signs results 1722 and the two previous vital signs results 1724. Color indicators may allow critical results to appear more prominently. The clinician may also select an orders button 1730 to launch the quick orders display area.

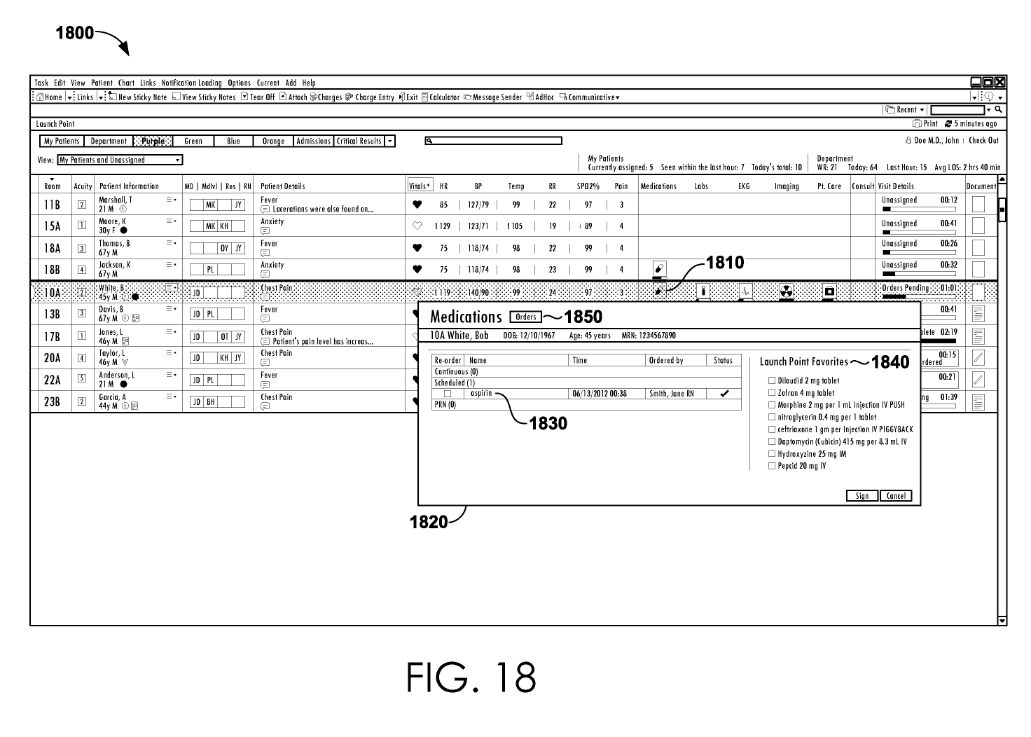

Referring now to FIG. 18, an illustrative screen display 1800 of an embodiment of the present invention is shown. By hovering over or interacting with the medications icon 1810, the medications summary 1820 is provided. The medications summary provides information regarding continuous medications, scheduled medications, and PRN medications. In this illustration, aspirin 1830 is a scheduled medication. The status of the medication may also be provided. Further, a checkbox may be provided next to the medication allowing the clinician to quickly re-order the medication. A quick order form 1840 is also provided allowing the clinical to quickly order medications that may be frequently ordered by that clinician, within that ED, or for a particular condition or diagnosis associated with the patient. The clinician may also select an orders button 1850 to launch the quick orders display area.

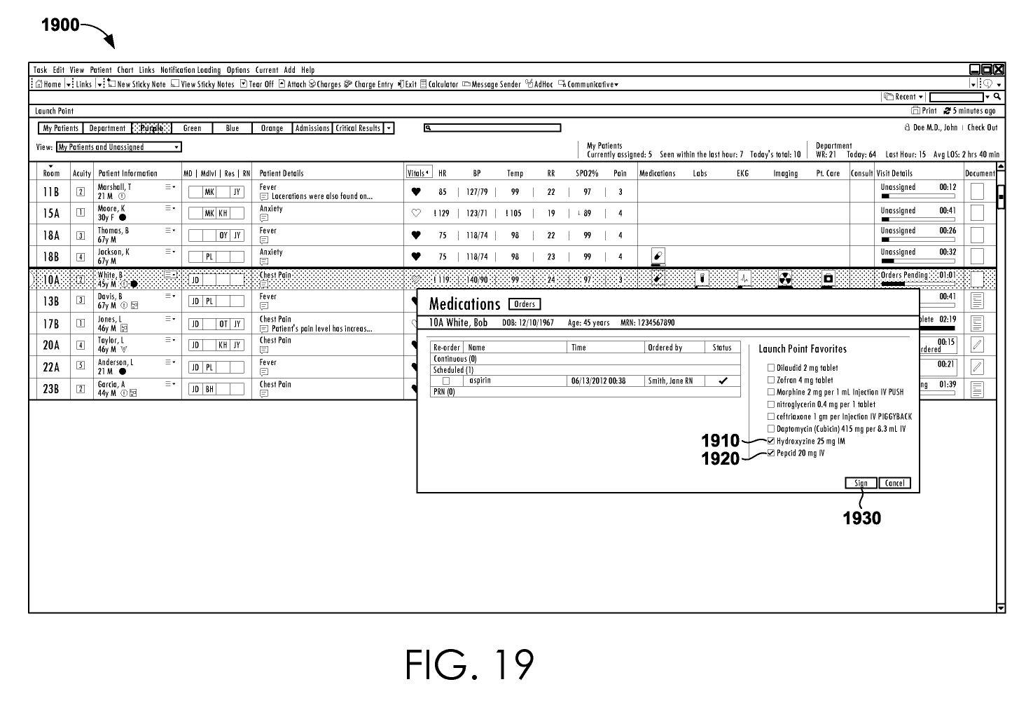

In FIG. 19, an illustrative screen display 1900 of an embodiment of the present invention is shown. In this example, the clinician has placed orders for two frequently ordered medications, Hydroxyzine 1910 and Pepcid 1920. The quick order form allows the clinician to sign the order directly within the quick order form, without opening another application or the patient's EMR, by selecting the sign button 1930.

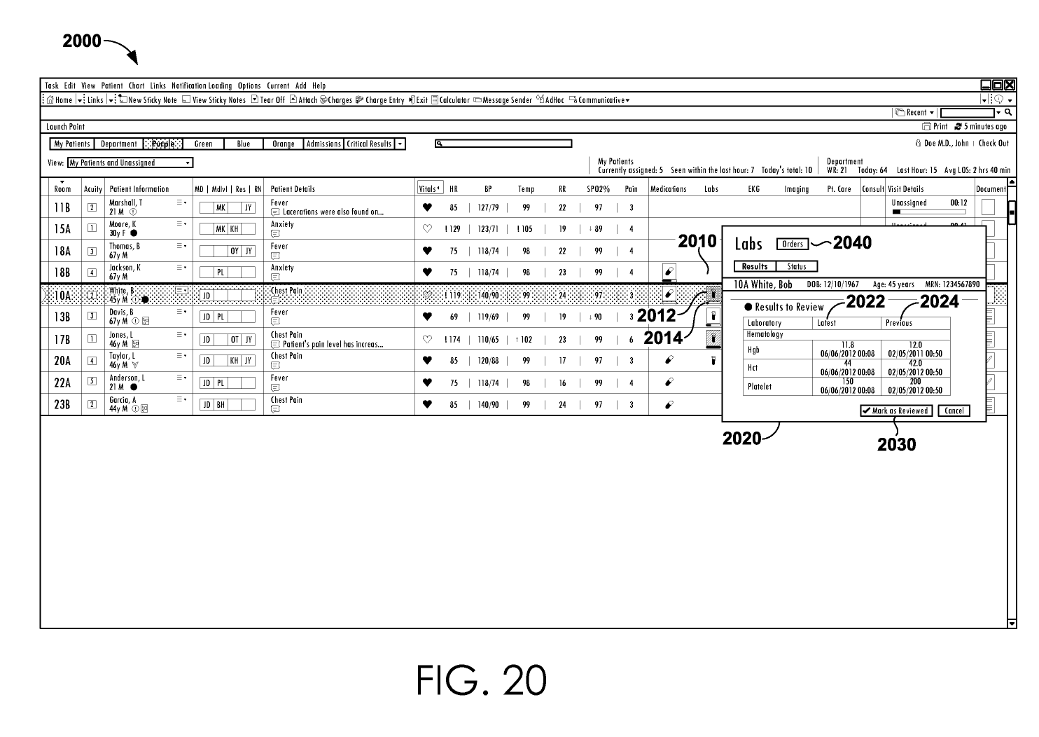

Turning now to FIG. 20, an illustrative screen display 2000 of an embodiment of the present invention is shown. By hovering over or interacting with the labs icon 2010, the labs summary 2020 is provided. The labs summary 2020 provides the latest lab results 2022 as well as previous lab results 2024. The appearance 2012 of the lab icon 2010 may be darker or lighter to let the clinician know that results are available that have not been reviewed by the clinician. A status bar 2014 indicates the status of the lab orders (e.g., complete, not completed, etc.). Color indicators may further indicate the status (e.g., overdue). After reviewing the results, the clinician may select a mark as reviewed 2030 to update the status of a particular lab as reviewed.

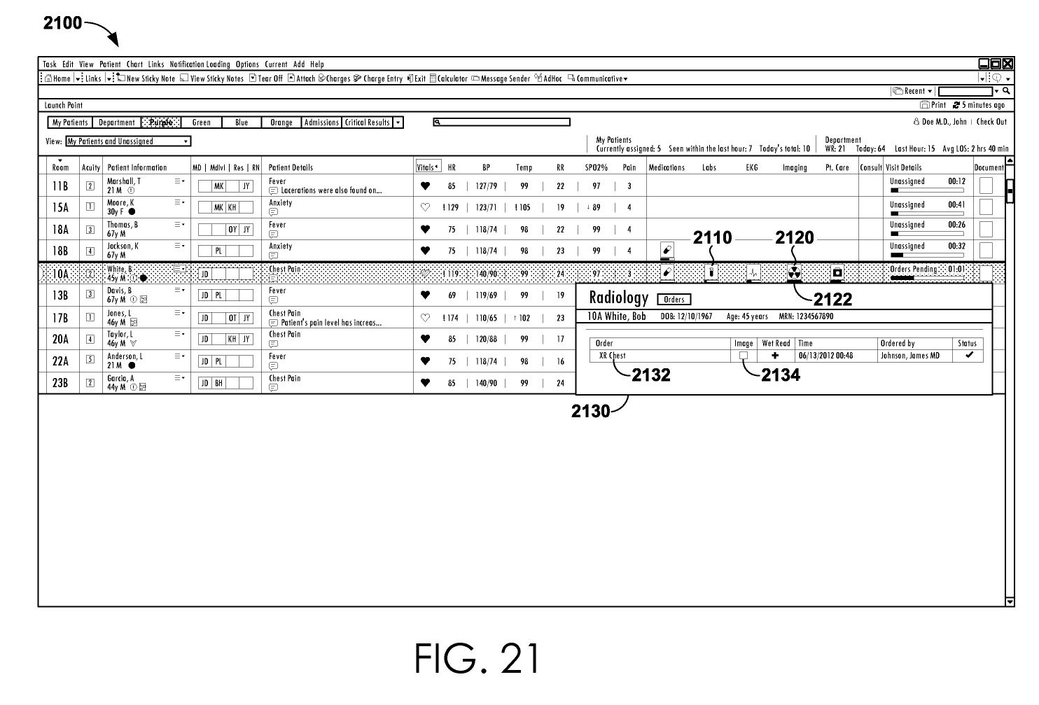

Referring now to FIG. 21, an illustrative screen display 2100 of an embodiment of the present invention is shown. As illustrated, the color of the lab icon 2110 has changed from grey to white, indicating that all available results have been reviewed. By hovering over or interacting with the images icon 2120, the images summary 2130 is provided. As illustrated, a status bar 2122 below the images icon 2120 indicates whether an order is complete. The status bar 2122 may be color coded in addition to showing progress associated with the status of the order. The images summary 2130 provides details of an images order 2132. An image box 2134 can be selected to launch or display the image.

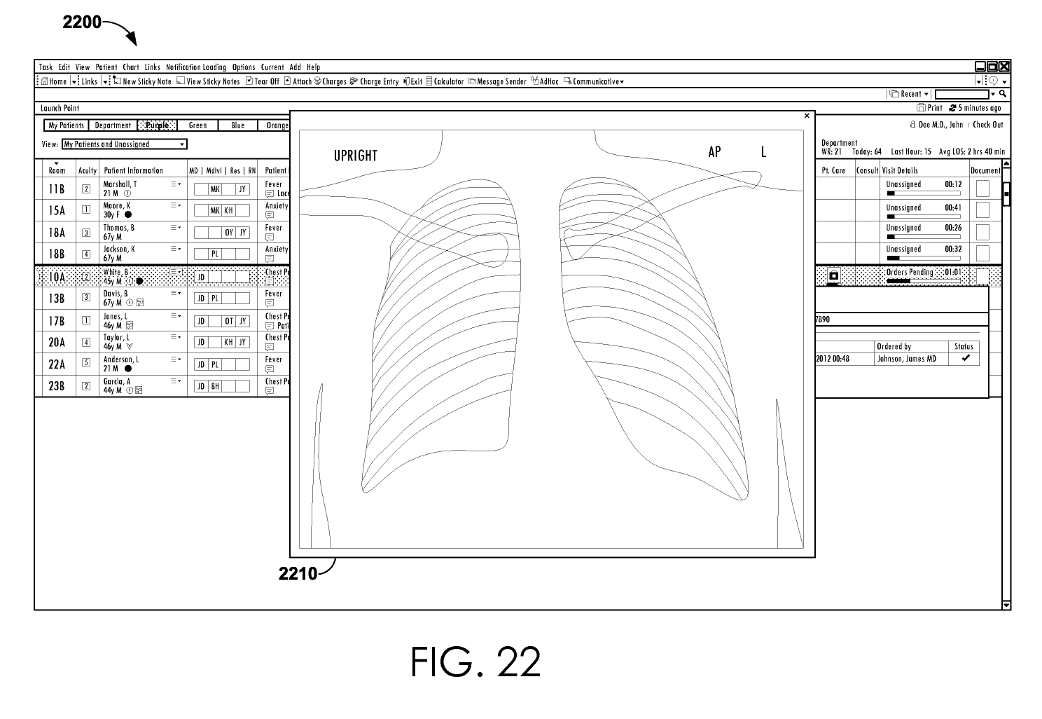

In FIG. 22, an illustrative screen display 2200 of an embodiment of the present invention is shown. As illustrated, the image box in FIG. 21 was selected and the image 2210 is launched or displayed. The image may be launched by a separate application or viewing system or may be displayed directly within the emergency department centralized interactive display (i.e., without opening a separate application).

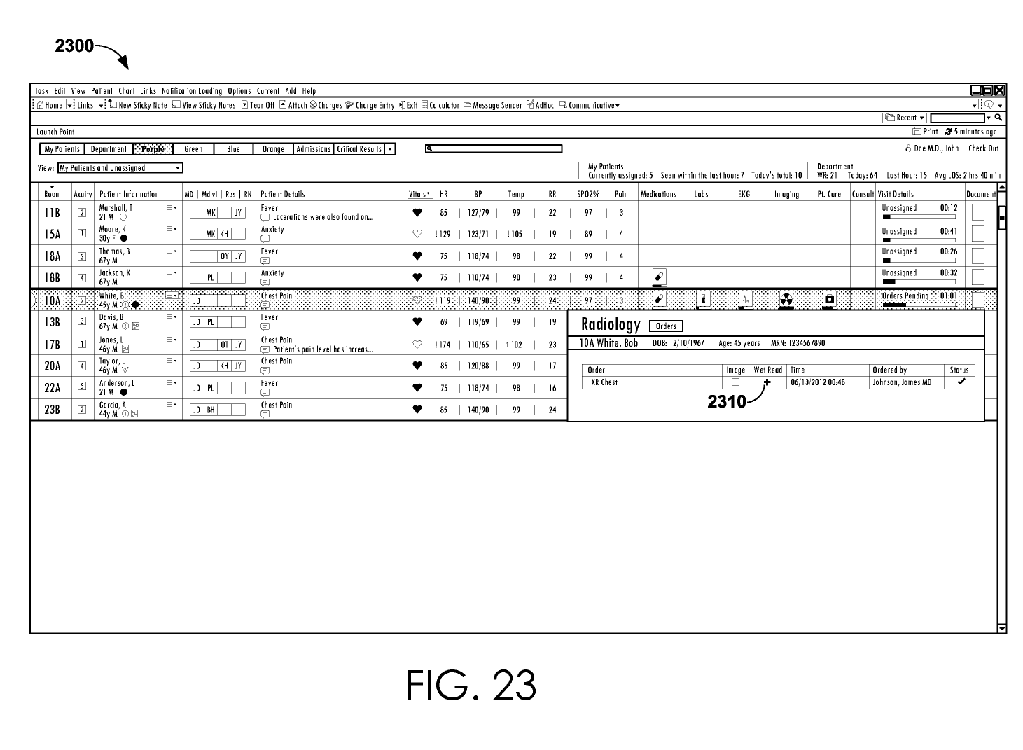

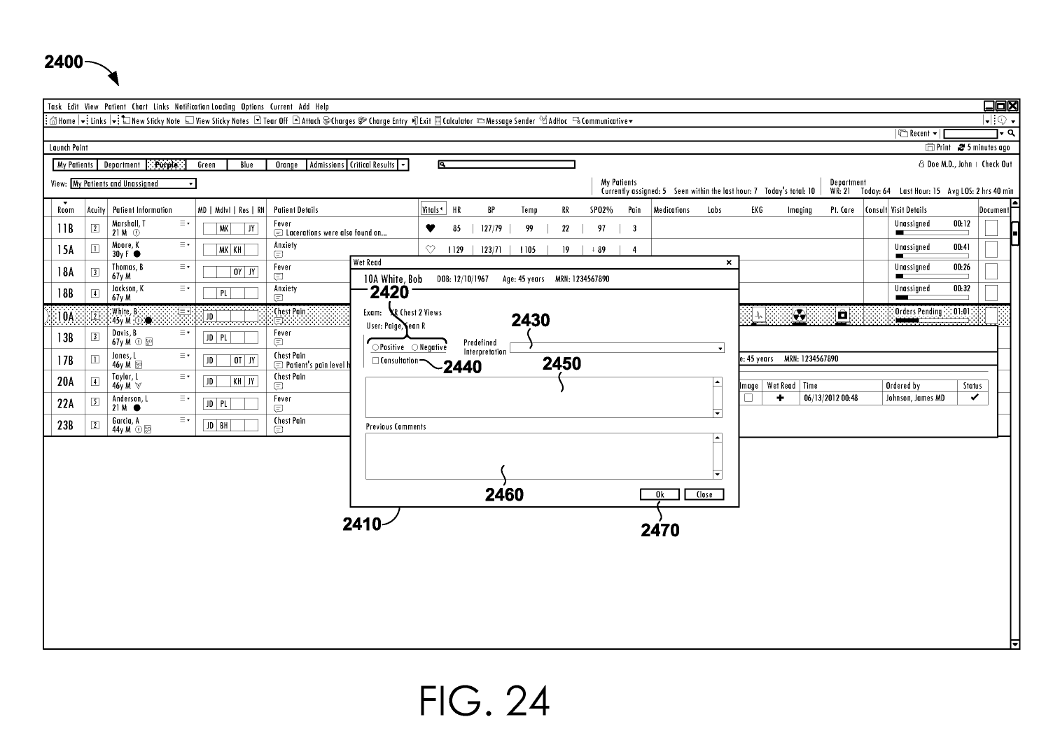

Turning now to FIG. 23, an illustrative screen display 2300 of an embodiment of the present invention is shown. Within the images summary, the clinician may also document a wet read of the image by selecting the wet read icon 2310. Referring now to FIG. 24, an illustrative screen display 2400 of an embodiment of the present invention is shown. After selecting the wet read icon as described with respect to FIG. 23, a wet read window 2410 is opened. The wet read window 2410 allows the clinician to indicate a positive or negative result 2420, select a predefined interpretation 2430, select whether a consultation 2440 is needed, provide comments 2450, review previous comments 2460, and save the wet read by selecting an ok button 2470.

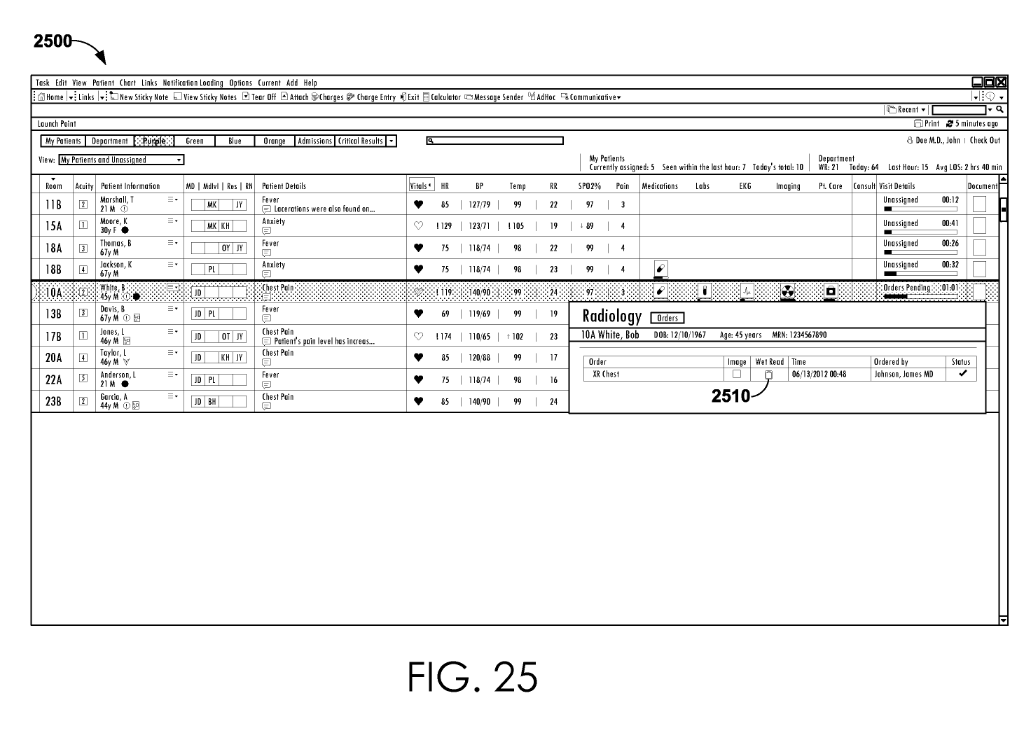

In FIG. 25, an illustrative screen display 2500 of an embodiment of the present invention is shown. Once the wet read has been provided as described with respect to FIG. 24, the wet read icon 2510 changes to let the clinician know that wet read has been documented for that particular image.

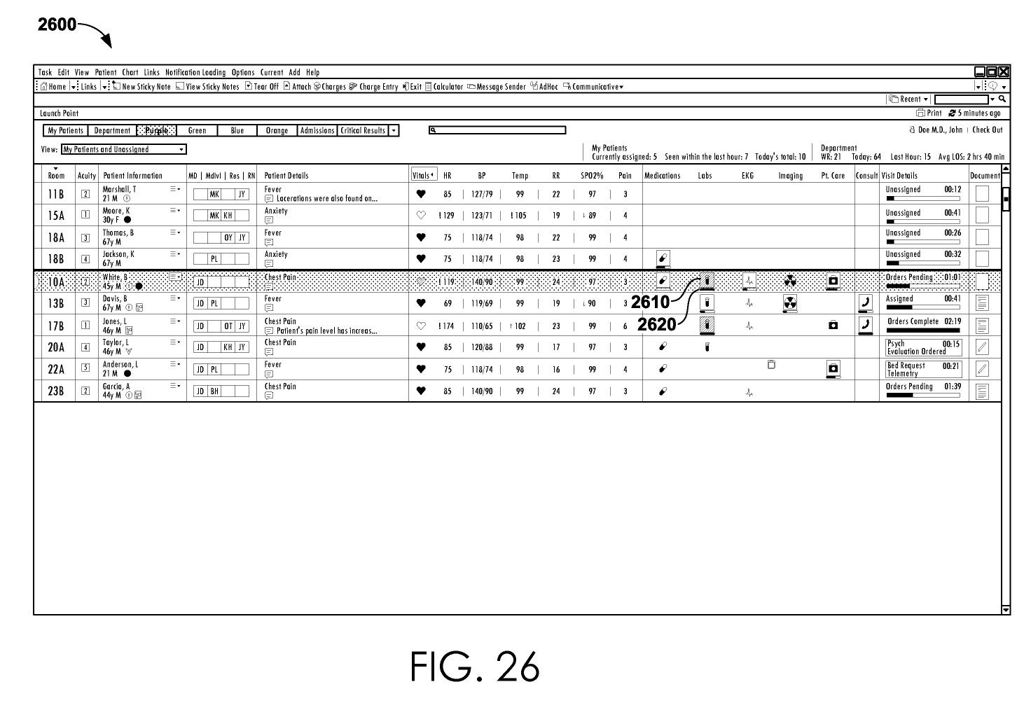

Turning now to FIG. 26, an illustrative screen display 2600 of an embodiment of the present invention is shown. As illustrated by the lab icon 2610, the status bar 2620 indicates that all lab orders are completed. The color of the lab icon may indicate whether a critical value has been received (e.g., red lab icon).

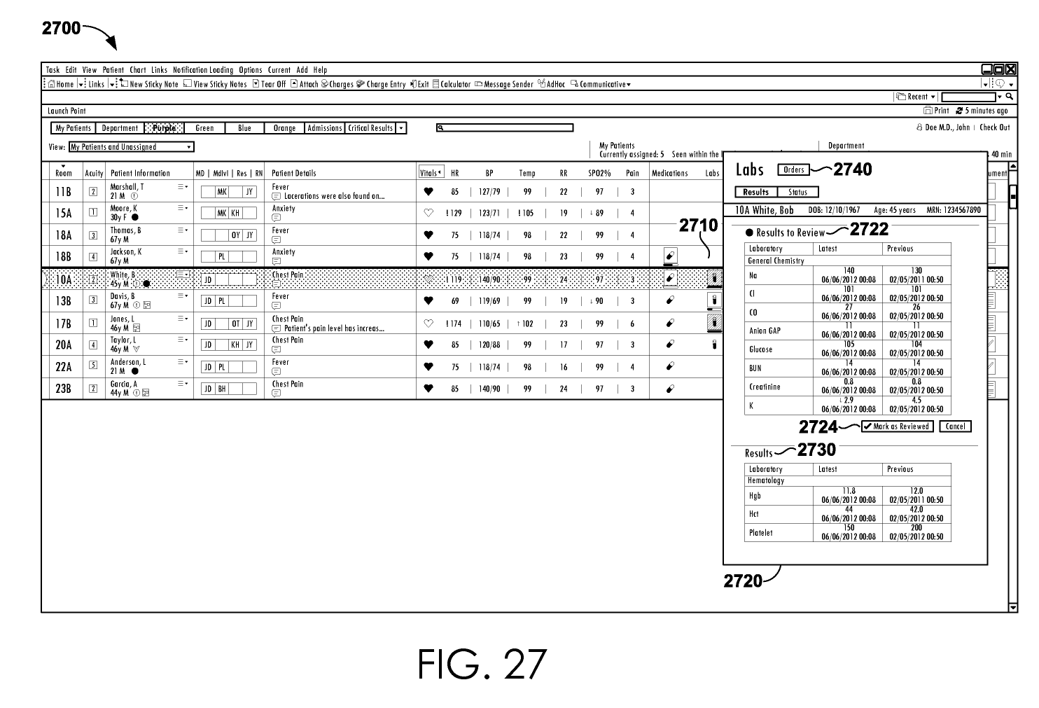

Referring now to FIG. 27, an illustrative screen display 2700 of an embodiment of the present invention is shown. By hovering over the lab icon 2710, the lab summary 2720 is provided. Results that need to be reviewed 2722 may appear more prominently than results that do not necessarily require review 2730. Once reviewed, the clinician can select a mark as reviewed button 2724. Any additional orders that may be desired may be placed by selected the orders button 2740 which opens the quick orders display area described herein.

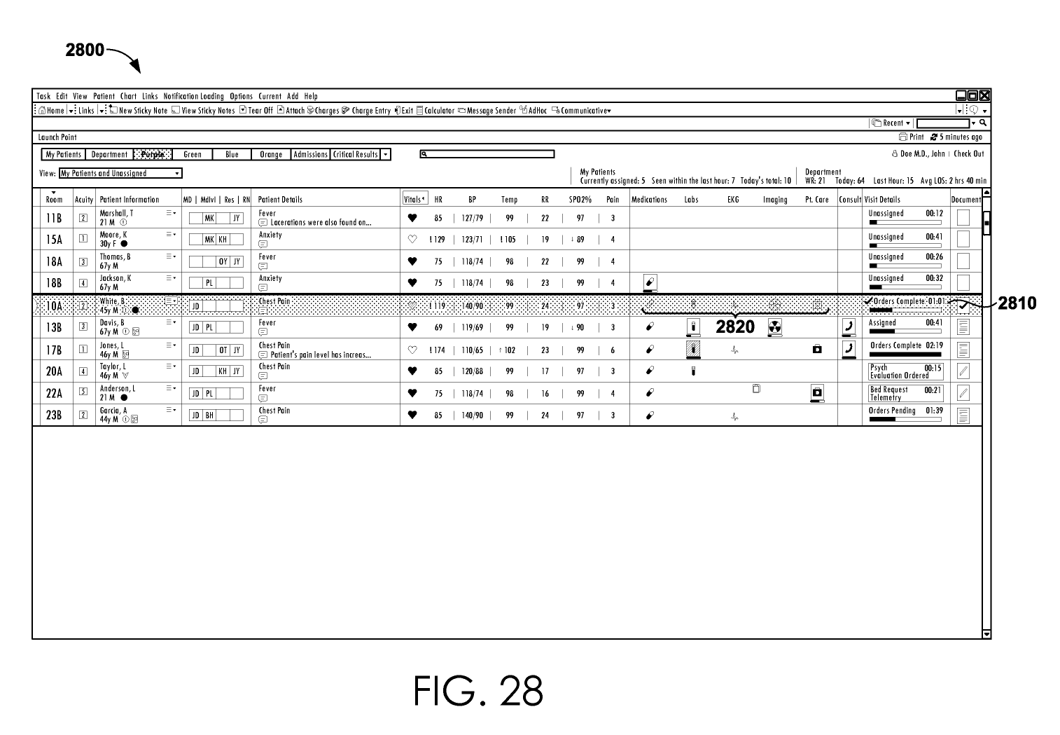

In FIG. 28, an illustrative screen display 2800 of an embodiment of the present invention is shown. After all orders are complete, the clinician is alerted by the length of stay display area 2810. The throughput display area may provide a similar indication. Each of the orders icons (e.g., medications, labs, EKG, imaging, and patient care) may also dithered out indicating that orders associated with each of the orders icons are complete.

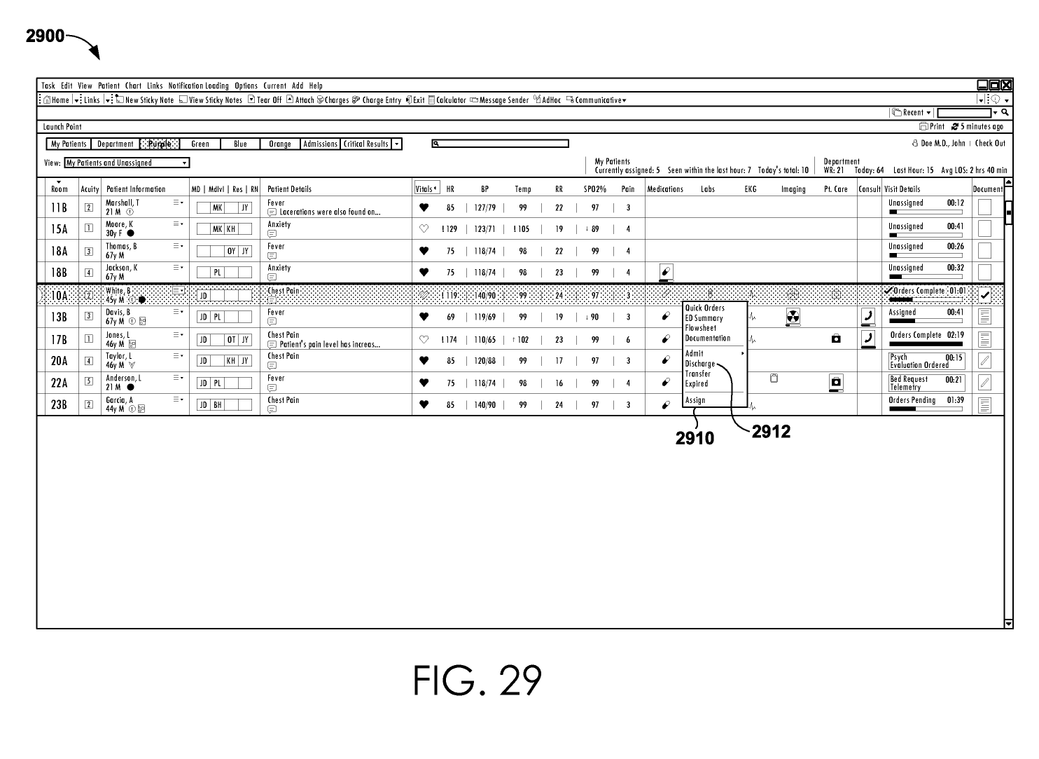

Turning now to FIG. 29, an illustrative screen display 2900 of an embodiment of the present invention is shown. After the orders are complete, for example, the clinician may determine the patient is ready to be discharged. The clinician may right click on the row associated with that patient and options 2910 are presented to the clinician. The clinician may select discharge 2912 (or another appropriate option).

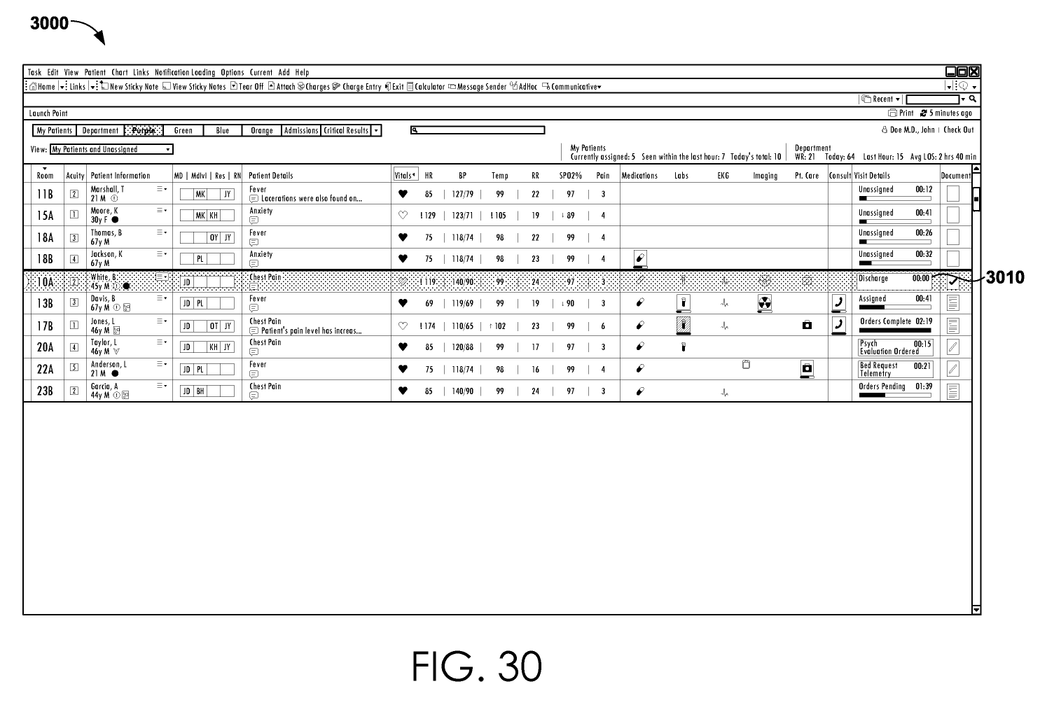

Referring now to FIG. 30, an illustrative screen display 3000 of an embodiment of the present invention is shown. As illustrated, the patient's status in the length of stay display area 3010 is updated to discharge. This status may also be updated in the throughput display area. Once the order to discharge the patient has been placed, the timer in the length of stay display area resets so the clinician and/or facility can track how long the patient waits to physically be discharged after the discharge order has been placed.

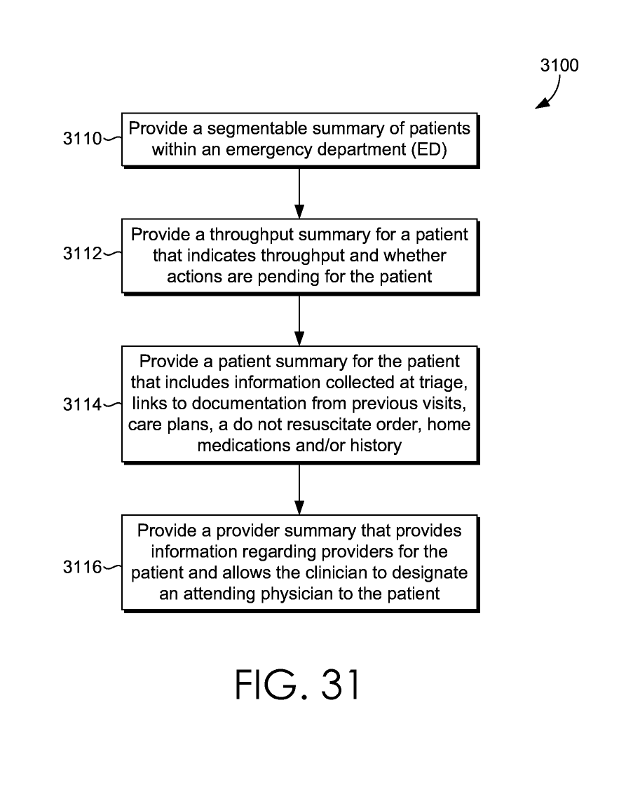

Referring now to FIG. 31, a flow diagram is illustrated showing an exemplary method 3100 of providing an emergency department centralized interactive display. As indicated at step 3110, a segmentable summary of patients within an emergency department (ED) is provided. The segmentable summary allows a clinician to view a specific area within the ED. The segmentable summary further allows a clinician to view a summary of patients assigned to the clinician. Unassigned patients may be included in the summary and may be sorted by acuity and length of stay. This allows a clinician to identify patients that may need a clinician assignment.

A throughput summary for a patient is provided, at step 3120, that indicates throughput and whether actions are pending for the patient. The throughput may indicate whether the patient is pending arrival, waiting for a clinician, an exam has been completed, orders are pending, orders are completed, the patient is ready for discharge, and/or the patient is pending admission.

At step 3130, a patient summary for the patient is provided that includes information collected at triage, links to documentation from previous visits, care plans, a do not resuscitate order, home medications, and/or history. The patient summary may further include a chief complaint provided by the patient, as well as any accompanying notes or comments.

A provider summary is provided, at step 3140, that provides information regarding providers for the patient and allows the clinician to designate an attending physician to the patient. Designating the clinician as the attending physician may enable the patient to be provided in the summary of patients and may specify initials of the clinician in the segmentable summary of patients. This allows a clinician to readily identify providers for a particular patient. The provider summary may include placeholders for specific clinician positions to maintain uniformity for the emergency department centralized interactive display.

In one embodiment, a vitals summary is provided that indicates the most recent vitals measurements, alerts the clinician if any vital readings are stale, alerts the clinician if any vital readings are critical and have not been reviewed, or alerts the clinician if no vital readings are available.

In one embodiment, a medications summary is provided that indicates medications that have been ordered or administered to the patient and allows the clinician to place new orders directly from an orders hover window associated with the medications summary and without having to go into a chart associated with the patient. Graphic indicators may provide, prior to activation or selection (e.g., opening) the medications summary, a progress of medication orders being placed, a ratio of complete versus incomplete medication orders, an indication of medication orders that need review, and/or a glow indication representing an overdue status.

In one embodiment, a laboratory summary is provided. The laboratory summary may indicate that results are completed. The laboratory summary may indicate that the results are overdue. The laboratory summary may indicate that the results have been reviewed. The laboratory summary may allow the clinician to review the results directly from a results hover window associated with the laboratory summary without having to go into the chart associated with the patient. Graphic indicators may provide, prior to activation or selection (e.g., opening) the laboratory summary, a progress of laboratory orders being placed, a ratio of complete versus incomplete laboratory orders, an indication of laboratory orders that need review, and/or a glow indication representing an overdue status.

In one embodiment, an electrocardiogram (EKG) summary. The EKG summary may provide details of an EKG order. The EKG summary may provide a status of the EKG. The EKG summary may provide a link to the EKG results. The link allows the clinician to open the EKG results directly from the emergency department centralized interactive display without having to open another application. Graphic indicators may provide, prior to activation or selection (e.g., opening) the EKG summary, a progress of EKG orders being placed, a ratio of complete versus incomplete EKG orders, an indication of EKG orders that need review, and/or a glow indication representing an overdue status.

In one embodiment, an images summary is provided. The images summary may provide a status of an order for an image. The images summary may further provide order details. A link to the image may be provided by the images summary that allows the clinician to open the image from the emergency department centralized interactive display without having to open another application. The images summary may further indicate a status of documentation for the image. The status may alert the clinician that documentation has been provided or that documentation is still needed. A link to provide documentation after the image is read may also be provided allowing the clinician to open a documentation window and provide documentation from the emergency department centralized interactive display without having to open another application. Graphic indicators may provide, prior to activation or selection (e.g., opening) the images summary, a progress of image orders being placed, a ratio of complete versus incomplete image orders, an indication of image orders that need review, and/or a glow indication representing an overdue status.

In one embodiment, a consult summary is provided that indicates whether a consult has been requested. The consult summary may further allow the clinician to perform the consult, such as by providing a button that initiates contact with the patient via a mobile device, via a computing device providing the emergency department centralized interactive display, or via the emergency department centralized interactive display itself. Graphic indicators may provide, prior to activation or selection (e.g., opening) the consult summary, a progress of consult orders being placed, a ratio of complete versus incomplete consult orders, an indication of consult orders that need review, and/or a glow indication representing an overdue status.

In one embodiment, a length of stay summary is provided that indicates a status associated with a length of stay. For example, the status may indicate a clinician has not been assigned to the patient yet. The status may indicate that orders are pending or complete for the patient. The status may indicate the order that is pending or that a particular order was not entered properly. The status may further indicate the patient is ready for discharge. The length of stay summary may include a timer to alert the clinician if a threshold has been exceeded for the patient. The timer may count up to indicate the current wait time or down to indicate how long the clinician has before a threshold is exceeded.

In one embodiment, a documentation summary is provided that indicates a status associated with documentation for the patient. The status may indicated that the clinician has already provided documentation, that no documentation has been provided, or that documentation is in progress (i.e., further documentation is needed). The documentation summary may further enable the clinician to update, edit, or document an event or encounter without having to open the patient's EMR. The documentation may be saved directly to the patient's EMR.

In one embodiment, a comments summary is provided that allows a clinician to provide comments that are provided for any clinician that is able to view the interactive display for that patient. Each clinician may also be able to open the comments summary to provide additional comments. This allows direct communication between all clinician caring for the patient. For example, a clinician may want to alert other clinicians treating the patient that the patient is in a particular unit receiving treatment (i.e., radiology). This allows other clinicians treating the patient to determine when the patient is available or ready for another treatment.

In one embodiment, an acuity summary for the patient is provided that indicates an acuity for the patient. The acuity may be color coded based on severity. The acuity may further have a numerical indicator providing the clinician additional information regarding the severity. The color coding and the numerical identifier serves as a visual triage indicator allowing the clinician to quickly identify the patient in the most urgent need of attention.

In one embodiment, in any of summary that is open or selected, tabs are provided for each of the other summaries that allow the clinician to selecting another summary to open by selecting the desired tab. This allows the clinician to quickly change the summary without closing the currently open summary and selecting a new summary from the interactive display. Similarly, the clinician can, from within each tab, place and review orders for the selected tab, without having to go into the chart associated with the patient.

The present invention has been described in relation to particular embodiments, which are intended in all respects to be illustrative rather than restrictive. Further, the present invention is not limited to these embodiments, but variations and modifications may be made without departing from the scope of the present invention.

It will be understood by those of ordinary skill in the art that the order of steps shown in methods 3000 of FIG. 30 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer hardware storage media storing computer-useable instructions that, when used by one or more computing devices, cause the one or more computing devices to perform a method of providing an emergency department centralized interactive display, the method comprising:
providing a segmentable summary of patients within an emergency department (ED), the segmentable summary allowing a clinician to view a specific area within the ED or a summary of patients assigned to the clinician including unassigned patients sorted by acuity and length of stay;
providing a throughput summary for a patient that indicates throughput and whether actions are pending for the patient, the throughput indicating whether the patient is pending arrival, waiting for a clinician, an exam has been completed, orders are pending, orders are completed, the patient is ready for discharge, and/or the patient is pending admission;
providing a patient summary for the patient that includes information collected at triage, links to documentation from previous visits, care plans, a do not resuscitate order, home medications, and/or history; and
providing a provider summary that provides information regarding providers for the patient and allows the clinician to designate an attending physician to the patient.

2. The media of claim 1, further comprising providing a medications summary that indicates medications that have been ordered or administered to the patient and allows the clinician to place new orders directly from an orders hover window associated with the medications summary and without having to go into a chart associated with the patient.

3. The media of claim 2, wherein graphic indicators provide, prior to activation of the medications summary, a progress of medication orders being placed, a ratio of complete versus incomplete medication orders, an indication of medication orders that need review, and/or a glow indication representing an overdue status.

4. The media of claim 3, further comprising providing a vitals summary that indicates the most recent vitals measurements, alerts the clinician if any vital readings are stale, alerts the clinician if any vital readings are critical and have not been reviewed, or alerts the clinician if no vital readings are available.

5. The media of claim 1, further comprising providing a laboratory summary that indicates whether results are completed, whether the results are overdue, whether the results have been reviewed, and allows the clinician to review the results directly from a results hover window associated with the laboratory summary and without having to go into the chart associated with the patient.

6. The media of claim 5, wherein graphic indicators provide, prior to activation of the laboratory summary, a progress of laboratory orders being placed, a ratio of complete versus incomplete laboratory orders, an indication of laboratory orders that need review, and/or a glow indication representing an overdue status.

7. The media of claim 1, further comprising providing an electrocardiogram (EKG) summary that provides details of EKG orders, a status of the EKG, and/or a link to the EKG results.

8. The media of claim 7, wherein graphic indicators provide, prior to activation of the EKG summary, a progress of EKG orders being placed, a ratio of complete versus incomplete EKG orders, an indication of EKG orders that need review, and/or a glow indication representing an overdue status.

9. The media of claim 1, further comprising providing an images summary that provides a status of an order for an image, order details, a link to the image, a status of documentation for the image, and/or a link to provide documentation after the image is read.

10. The media of claim 9, wherein graphic indicators provide, prior to activation of the images summary, a progress of image orders being placed, a ratio of complete versus incomplete image orders, an indication of image orders that need review, and/or a glow indication representing an overdue status.

11. The media of claim 1, further comprising providing a consult summary that indicates whether a consult has been requested and allows the clinician to perform the consult.

12. The media of claim 11, wherein graphic indicators provide, prior to activation of the consult summary, a progress of consult orders being placed, a ratio of complete versus incomplete consult orders, an indication of consult orders that need review, and/or a glow indication representing an overdue status.

13. The media of claim 1, further comprising providing a length of stay summary that indicates a status associated with a length of stay and includes a timer to alert the clinician if a threshold has been exceeded for the patient.

14. A computer system for providing an emergency department centralized interactive display, the computer system comprising one or more processors coupled to a computer storage medium, the computer storage medium having stored thereon a plurality of computer software components executable by the one or more processors, the computer software components comprising:
a patient summary component that provides a patient summary for a patient that includes information collected at triage, links to documentation from previous visits, care plans, a do not resuscitate order, home medications, and/or history;
a provider summary component that provides a provider summary that provides information regarding providers for the patient and allows the clinician to designate an attending physician to the patient;
a vitals summary component that provides a vitals summary that indicates the most recent vitals measurements and further indicates if any vital readings are stale, critical and/or have not been reviewed, or if no vital readings are available;
a medications summary component that provides a medications summary that indicates medications that have been ordered or administered to the patient and allows the clinician to place new orders directly from an orders hover window associated with the medications summary and without having to go into a chart associated with the patient;
a laboratory summary component that indicates whether results are completed, whether the results are overdue, whether the results have been reviewed, and allows the clinician to review the results directly from a results hover window associated with the laboratory summary and without having to go into the chart associated with the patient;
an electrocardiogram (EKG) summary component that provides an electrocardiogram (EKG) summary that provides details of EKG orders, a status of the EKG, and/or a link to the EKG results;
an images summary component that provides an images summary that provides a status of an order for an image, order details, a link to the image, a status of documentation for the image, and/or a link to provide documentation after the image is read;
a length of stay summary component that provides a length of stay summary that indicates a status associated with a length of stay and includes a timer to alert the clinician if a threshold has been exceeded for the patient;
a documentation summary component that provides a documentation summary that indicates a status associated with documentation for the patient and enables the clinician to update the documentation; and
an acuity summary component that provides an acuity summary for the patient that indicates an acuity for the patient.

15. The computer system of claim 14, further comprising a consult summary component that provides a consult summary that indicates whether a consult has been requested and allows the clinician to perform the consult.

16. The computer system of claim 14, further comprising a throughput component that provides a throughput summary for a patient that indicates throughput and whether actions are pending for the patient, the actions indicating one or more issues are preventing the dismissal of the patient, wherein the throughput indicates whether the patient is pending arrival, waiting for a clinician, an exam has been completed, orders are pending, orders are completed, the patient is ready for discharge, and/or the patient is pending admission.

17. Computer storage media having computer-executable instructions embodied thereon that, when executed by one or more computing devices, cause the one or more computing devices to produce a graphical user interface (GUI) for providing an emergency department centralized interactive display, the GUI comprising:
a segment display area that displays a view of a specific area within the ED or a summary of patients assigned to the clinician including unassigned patients sorted by acuity and length of stay;
an acuity display area that displays an acuity for the patient, the acuity being color coded based on severity;
a throughput display area that displays throughput for a patient and indicates whether actions are pending for the patient, the throughput indicating whether the patient is pending arrival, waiting for a clinician, an exam has been
completed, orders are pending, orders are completed, the patient is ready for discharge, and/or the patient is pending admission;
a patient display area that displays information collected at triage, links to documentation from previous visits, care plans, a do not resuscitate order, home medications, and/or history;
a provider display area that displays information regarding providers for the patient and allows the clinician to designate an attending physician to the patient, the provider display area including placeholders for specific clinician positions to maintain uniformity for the provider display area for each patient;
a consult display area that displays whether a consult has been requested and allows the clinician to initiate the consult; and
an orders/vitals display area that displays an order summary that indicates a status associated with orders for the patient and a vitals summary that indicates the most recent vitals measurements, displays alerts to the clinician if any vital readings are stale, displays alerts to the clinician if any vital readings are critical and have not been reviewed, or displays alerts to the clinician if no vital readings are available.

18. The media of claim 17, wherein the GUI further comprises a documentation display area that indicates a status associated with documentation for the patient and allows a clinician to provide additional documentation.

19. The media of claim 18, wherein the order summary includes: a medications summary that indicates medications that have been ordered or administered to the patient and allows the clinician to place new orders directly from an orders hover window associated with the medications summary and without having to go into a chart associated with the patient; a laboratory summary that that indicates whether results are completed, whether the results are overdue, whether the results have been reviewed, and allows the clinician to review the results directly from a results hover window associated with the laboratory summary and without having to go into the chart associated with the patient; an electrocardiogram (EKG) summary that provides details of EKG orders, a status of the EKG, and/or a link to the EKG results; and an images summary that provides a status of an order for an image, order details, a link to the image, a status of documentation for the image, and/or a link to provide documentation after the image is read.

20. The GUI of claim 19, wherein the GUI further comprises a length of stay display area that displays a status associated with a length of stay and includes a timer to alert the clinician if a threshold has been exceeded for the patient.
